(19) United States
(12) Patent Application Publication
(10) Pub. No.: US 2016/0330601 A1
(43) Pub. Date: Nov. 10, 2016

(54) METHOD AND SYSTEM FOR MANAGING PUBLIC SAFETY IN AT LEAST ONE OF UNKNOWN, UNEXPECTED, UNWANTED AND UNTIMELY SITUATIONS VIA OFFERING INDEMNITY IN CONJUNCTION WITH WEARABLE COMPUTING AND COMMUNICATIONS DEVICES

(71) Applicant: VIKAS SRIVASTAVA, BANGALORE (IN)

(72) Inventor: VIKAS SRIVASTAVA, BANGALORE (IN)

(21) Appl. No.: 14/995,205

(22) Filed: Jan. 14, 2016

Related U.S. Application Data
(63) Continuation-in-part of application No. 62/187,261, filed on Jul. 1, 2015.
(60) Provisional application No. 62/157,499, filed on May 6, 2015.

(51) Int. Cl. H04W 4/22; G06Q 50/26; B64C 39/02; H04W 4/00

(52) U.S. Cl. CPC H04W 4/22; H04W 4/005; G06Q 50/265; B64C 39/024; B64C 2201/126; B64C 2201/141

(57) ABSTRACT

Embodiments of the present invention disclose design, deployment and implementation of systems capable of facilitating managing public safety (or security) in one or more situations, and methods thereof, in accordance with the principles of the present invention. Specifically, the systems may facilitate managing public safety (or security) in one or more situations of at least one of danger, untoward incident, accident, emergency, loss and death with one or more enhanced qualitative and quantitative features, such as minimal vulnerability, real-time notification ability and automatic evidence manageability, thereby facilitating timely prevention, Quick Response (QR) or (Just-In-Time or JIT) response, speedy trial, effective prosecution, easy enforceability and policing, and methods thereof in accordance with the principles of the present invention.

### CROSS-REFERENCE TO RELATED APPLICATIONS

This application claims benefit of the U.S. Provisional Patent Application No. 62/157,499 filed May 6, 2015, which is incorporated herein by reference in its entirety. Further, this application is a continuation-in-part of the U.S. Provisional Patent Application No. 62/187,261 filed Jul. 1, 2015, which is incorporated herein by reference in its entirety.

### BACKGROUND OF THE INVENTION

1. Field of the Invention

Embodiments of the present invention generally relate to public safety (or security) in one or more situations, and more particularly, managing public safety in one or more situations of at least one of danger, untoward incident, accident, emergency, loss and death using systems with one or more enhanced qualitative and quantitative features, such as minimal vulnerability, real-time notification ability and automatic evidence manageability, thereby facilitating timely prevention, Quick Response (QR) or (Just-In-Time or JIT) response, speedy trial, effective prosecution, easy enforceability and policing, and methods thereof.

2. Description of the Related Art

Public safety personnel, such as police officers, firefighters, paramedics and the like, as well as business critical users such as manufacturing, hospital, and public service workers typically utilize multiple communication devices. While some of these devices may operate on government or enterprise networks with emergency features, others may not.

Public safety communication devices include, for example, mobile radios such as handheld radios and/or vehicular radios along with remote accessories, such as remote microphones, speakers, earpieces, headsets and the like. This type of equipment (considered primary mission critical devices) and the infrastructure to support its operation is typically accomplished utilizing a Private Network governed by a public safety agency. Primary devices for use in mission critical applications often include a user interface having an emergency button for transmitting an emergency alert notification as well as push-to-talk (PTT) capability which allows a worker to request additional back-up resources in high stress situations.

The additional non public safety types of devices often utilized by public safety personnel are considered non-mission critical devices, such as cell phones, personal digital assistants, electronic notepads which operate over a Public Carrier network. These secondary, non-mission critical devices do not provide a user interface for high stress emergency environments. Public safety personnel often call upon back-up resources in a dangerous situation. However, when PTT voice requests for back-up resources are communicated over a radio system or cellular network, requests may not be heard by dispatchers or work partners due to coverage holes, network congestion, talk-over, or work partner task focus. The public safety worker who presses the emergency button or push-to-talk button to request back-up may not be able to readily repeat the request when operating in a high stress situation. Additionally, the public safety worker may not be aware that the request has failed, further jeopardizing safety.

Accordingly, there is a need for an improved communication system which will enhance emergency and back-up requests in public safety applications.

### SUMMARY OF THE INVENTION

Embodiments of the present invention disclose design, deployment and implementation of systems capable of facilitating managing public safety (or security) in one or more situations, and methods thereof, in accordance with the principles of the present invention. Specifically, the systems facilitate managing public safety (or security) in one or more situations of at least one of danger, untoward incident, accident, emergency, loss and death with one or more enhanced qualitative and quantitative features, such as minimal vulnerability, real-time notification ability and automatic evidence manageability, thereby facilitating timely prevention, Quick Response (QR) or (Just-In-Time or JIT) response, speedy trial, effective prosecution, easy enforceability and policing, and methods thereof in accordance with the principles of the present invention.

Embodiments of the present invention disclose a method for design and implementation of an integrated comprehensive public safety and emergency communication system involving use of at least one of portable and wearable computing and communications devices and unmanned aerial vehicles. The method comprises customizing design of the at least one of portable and wearable computing and communications devices and proprietary application software thereof, thereby rendering the devices at least one of tamper-proof, tamper-resistant, tamper-evident and operable in at least one of one or more low power, secure encrypted, data encryption and encrypted communication modes, customizing implementation of the at least one of custom-designed portable and wearable computing and communications devices and the proprietary application software thereof, thereby rendering the same fault-tolerant, fail safe and operable in at least one of real-time and near real-time, configuring the at least one of custom-designed and implemented portable and wearable computing and communications devices and the proprietary mobile application software thereof for use in at least one of unknown, unexpected, unwanted and untimely situations, at least one of automatically and partially manually capturing at least one of textual data, still images, video, audio and a combination thereof in at least one of unknown, unexpected, unwanted and untimely situations as evidence using the at least one of custom-designed and implemented portable and wearable computing and communications devices, thereby facilitating timely management of the aforementioned situations, at least one of automatically and partially manually, simultaneously storing the captured data for processing and later use plus transmitting the captured data in at least one of real-time and near real-time, using at least one of one or more available wireless networks based on one or more wireless video and data distribution techniques, to at least one of primary recipients, emergency contacts and a combination thereof, upon failure to receive at least one of proof of delivery, read, approval receipt and a combination thereof from the primary recipients, at least one of automatically and partially manually forwarding the captured data to one or more peers of the primary recipients, upon failure to receive at least one of proof of delivery, read, approval receipt and a combination thereof from the peers of the primary recipients, at least one of automatically and partially manually forwarding the captured data to one or more supervisors of the primary recipients and peers thereof, and upon receipt of at least one of proof of delivery, read, approval receipt and a combination thereof from at least one high-level strategic decision making public authority managing the at least one of law enforcing, policing, fire and other emergency disaster management authorities, at least one of automatically and autonomously flying the UAVs to the detected locations in connection with at least one of unknown, unexpected, unwanted and untimely situations.

In some embodiments, the at least one of portable and wearable computing and communications devices are designed to be implemented in, or automatically select from and implement, or selectively implement from, one or more user-defined explicit operation modes based on at least one of selective activation, deactivation and a combination thereof of one or more add-on components thereof. For instance, the one or more add-on components are at least one of an imaging device, a GPS sensor (receiver), GSM unit, one or more additional sensors, one or more auxiliary wireless communication units and one or more auxiliary positioning units. Specifically, the one or more user-defined explicit operation modes based on at least one of selective activation, deactivation and a combination thereof of one or more add-on components thereof are at least one of mapped onto and correspond to one or more potential real-time use case scenarios in connection with the at least one of unknown, unexpected, unwanted and untimely situations. For instance, the one or more real-time use case scenarios in connection with the at least one of unknown, unexpected, unwanted and untimely situations require at least one of a microphone, imaging device and a combination thereof based on the level of severity, and the kind of security required therefor.

In some embodiments, the at least one of portable and wearable computing and communications devices are designed to be implemented in, or automatically select from and implement, or selectively implement from, one or more user-defined explicit operation modes based on selective failover to one or more standby wireless networks upon at least one of network failure, unavailability and timeout.

In one aspect of the present invention a method of managing event-based people detection and tracking comprises capturing one or more attributes of at least one of an event, people, timings, location, ambience and incidents thereof, profiling people based on at least one of the location of the event, timings associated with the event, ambience in the vicinity of the event, incidents occurring in the event and at least a combination thereof, categorizing people based at least in part on the profiling, generating user-defined rules for at least one of detection and tracking of people and a combination thereof based on the categories of the people, providing recommendations in connection with at least one of detection and tracking of people and a combination thereof based on the categories of the people, and tracking the efficacy of the recommendations.

In another aspect of the present invention a method for event-based tracking of a target person by detection comprises generating and storing a historical profile of the target person based on one or more attributes of the target person and behavior of the target person as a participant in past events similar to an instant event, generating and storing historical profiles of locations traversed by the target person during the past events similar to the instant event in a venue therefor, generating and storing historical profiles of peers with whom the target person interacted during the past events similar to the instant event, generating and storing historical profiles of incidents the target person met with during the past events similar to the instant event, generating and storing historical profiles of ambient conditions the target person was exposed to during the past events similar to the instant event, detecting and capturing locations traversed by the target person during the instant event in a venue therefor, detecting and capturing peers with whom the target person interacted during the instant event, detecting and capturing incidents the target person meets with during the instant event, detecting and capturing ambient conditions the target person is exposed to during the instant event, comparing each of the detected and captured locations, peers, incidents and ambient conditions in connection with the instant event and generated and stored profile of the target person against the generated and stored profiles of the locations, peers, incidents and ambient conditions in connection with past events similar to the instant event and finding maximum matching results based on the comparison.

In still another aspect of the present invention disclose a method managing event-based people detection and tracking. The method comprises capturing one or more attributes of an instant event and past events, similar to the instant event, capturing one or more attributes of people participating in the instant event and past events, similar to the instant event, capturing one or more attributes of locations traversed by the people during the instant event and past events, similar to the instant event, capturing one or more attributes of incidents faced by the people during the instant event and past events, similar to the instant event, capturing one or more attributes of ambient conditions met by the people during the instant event and past events, similar to the instant event, generating profiles of the people based on the captured attributes, categorizing the people based on their corresponding profiles, generating user-defined rules for detecting and tracking people based on the categories, providing recommendations in connection with selection and implementation of one or more of the generated rules for detecting and tracking people and tracking the efficacy of the recommendations.

These and other systems, processes, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE DRAWINGS

FIG. 1 depicts a block diagram of a system for managing public safety in at least one of unknown, unexpected, unwanted and untimely situations, according one or more embodiments;

FIG. 2 depicts a first exemplary pictorial representation in connection with implementation of the system 100, of FIG. 1 and method thereof, in at least one of unknown, unexpected, unwanted and untimely situations, according to one or more embodiments;

FIG. 3 depicts a second exemplary pictorial representation in connection with implementation of the system 100, of FIG. 1 and method thereof, in one or more potentially dangerous situations, according to one or more embodiments;

FIG. 4 depicts a third exemplary pictorial representation in connection with implementation of the system 100, of FIG. 1 and method thereof, in one or more potentially dangerous situations, according to one or more embodiments;

FIG. 5 depicts a potential use case scenario involving deployment and implementation of the system facilitating streamlined, seamless, continuous connectivity Anytime, Anywhere and Anyhow to a remote server subsystem to persons owning the wearable computing devices, according one or more embodiments;

FIGS. 6A-B depict a flow diagram in connection to the method for the design and implementation of the integrated comprehensive public safety and emergency communication system, according to one or more embodiments;

FIG. 7 depicts a block diagram of an embedded device management system for use in the at least one of portable and wearable computing and communications devices, according to one or more embodiments; and

FIG. 8 depicts a computer system that may be a computing device and may be utilized in various embodiments of the present invention.

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

While the method and system is described herein by way of example for several embodiments and illustrative drawings, those skilled in the art will recognize that the method and system for managing public safety in at least one of unknown, unexpected, unwanted and untimely situations via offering indemnity in conjunction with wearable computing and communications devices, is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and system for managing public safety in at least one of unknown, unexpected, unwanted and untimely situations via offering indemnity in conjunction with wearable computing and communications devices defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

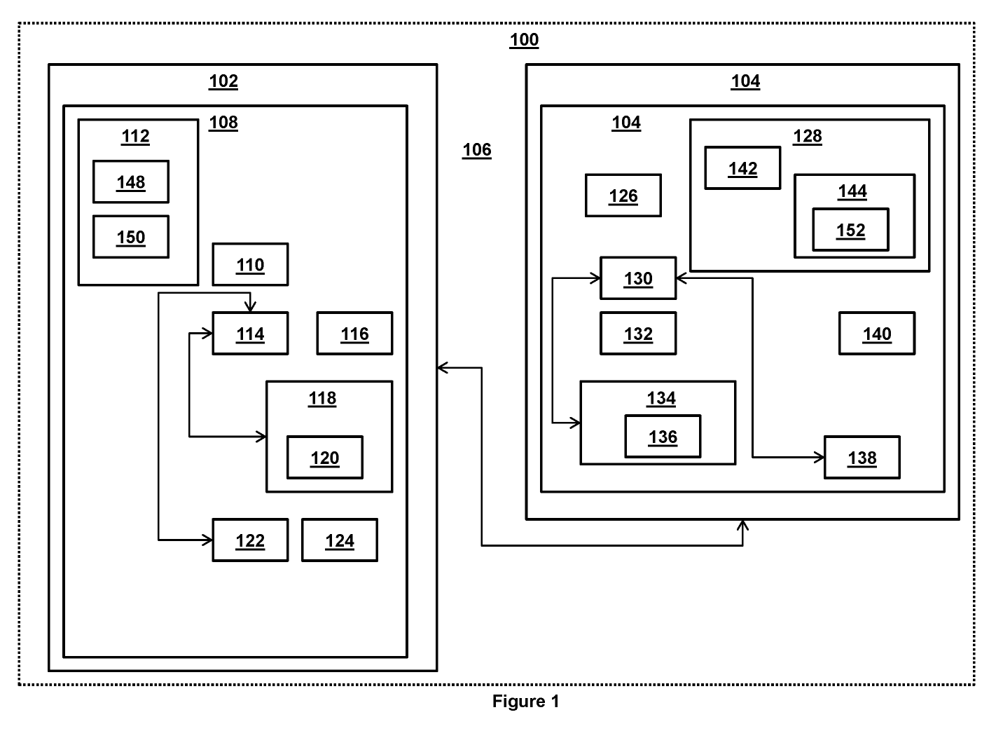

FIG. 1 depicts a block diagram of a system for managing public safety in at least one of unknown, unexpected, unnatural, unwanted, unjust and untimely situations, according to one or more embodiments. Specifically, the system facilitates managing public safety in at least one of known, unknown, expected, unexpected, natural, unnatural, wanted, unwanted, just, unjust, timely and untimely situations eventuating anytime, anywhere and anyhow at least one of A) autonomously, automatically by virtue of involvement of nobody and nothing, B) partially manually, fully manually, and combinations thereof, by virtue of at least one of active and passive contribution of anybody, anything, and combinations thereof as well as owing to interactions therebetween, for instance at least one of direct and indirect actions by, reactions from and impact on physical objects, human subjects and combinations thereof as well as interactions therebetween, in accordance with the principles of the present invention.

The system 100 is in essence an integrated comprehensive public safety (or security) management system. The system 100 comprises a server subsystem 102, client subsystem 104 and network subsystem 106.

The server subsystem 102 comprises one or more host computing units 108. Each of the host computing units 108 comprises a first microprocessor subunit 110, first memory subunit 112, first Input/Output subunit 114 and first set of support circuits 116, respectively. In addition, the host computing unit 108 comprises a first communication subunit 118 coupled to the first I/O subunit 114. The first communication subunit 118 comprises a first wireless transceiver 120.

For example, and in no way limiting the scope of the invention, the first wireless transceiver 120 comprises at least one of a General Packet Radio Service (GPRS) transceiver, Global System for Mobile Communications (GSM) transceiver, Near Field Communication (NFC) transceiver, BLUETOOTH® transceiver, and the like. In addition, each of the host computing units 108 comprises a first display subunit 122. In some embodiments, both the first communication subunit 118 and first display subunit 122 are coupled to the first I/O subunit 114. In addition, each of the host computing units 108 comprises a first positioning subunit 124. For example, and in no way limiting the scope of the invention, the first positioning subunit 124 is based on Global Positioning System (GPS).

The first memory sub-unit 112 comprises a first Operating System (OS) 148. Specifically, the first OS 148 is a platform agnostic/independent OS. In addition, the first memory sub-unit 112 comprises a server-side 150 of a proprietary Service-Oriented Architecture (SOA)-based Public Safety-As-A-Service (SOAPSAAS) application (app) 146 (not shown here explicitly). The proprietary SOAPSAAS application (app) 146 is in essence a client-server application, which is a distributed system made up of both client and server software.

In operation, the proprietary client-server SOAPSAAS application (app) 146 provides a better way to share the workload. A client-side 152 of the proprietary client-server SOAPSAAS application (app) 146 installed and running on any client, for instance the client subsystem 104 comprising at least one of the smart portable and wearable computing and communications devices 104, always initiates a connection to the server, for instance the sever subsystem 102 comprising the host computing unit 108, while the server-side 150 of the proprietary client-server SOAPSAAS application (app) 146 always waits for requests from any client.

The term “Service-Oriented Architecture or SOA” refers to an architectural pattern in computer software design, wherein application components provide services to other components via a communications protocol, typically over a network. The principles of service-orientation are independent of any vendor, product or technology, thereby rendering the SOA at least one of vendor, product, technology agnostic and a combination thereof.

In some embodiments, the client subsystem 104 comprises one or more of at least one of a portable computing device, portable communications device and a combination thereof, for instance a portable computing and communications device.

In some embodiments, the portable computing devices are at least one of a portable computer, tablet computer, Personal Digital Assistant (PDA), an ultra mobile PC, a smart phone, carputer, portable communications, pentop computer, and the like. Likewise, in some embodiments, the portable communications devices are at least one of a mobile device, and the like.

In some embodiments, the client subsystem 104 comprises one or more of at least one of a wearable computing device, wearable communications device and a combination thereof, for instance a wearable computing and communications device. For example, and in no way limiting the scope of the invention, the wearable computing devices are at least one of a smart watch, smart band, smart glass, smart shoe, and the like.

In some embodiments, the at least one of portable and wearable computing and communications device 104 comprises a second microprocessor subunit 126, second memory subunit 128, a second Input/Output (I/O) subunit 130 and second set of support circuits 132, respectively. In addition, the at least one of portable and wearable computing and communications device 104 comprises a second communication subunit 134 coupled to the second I/O subunit 130. The second communication subunit 134 comprises a second wireless transceiver 136.

For example, and in no way limiting the scope of the invention, the second wireless transceiver 136 comprises at least one of a General Packet Radio Service (GPRS) transceiver, Global System for Mobile Communications (GSM) transceiver, Near Field Communication (NFC) transceiver, BLUETOOTH® transceiver, and the like. In addition, the at least one of portable and wearable computing and communications device 104 comprises a second display subunit 138. In some embodiments, both the second communication subunit 134 and second display subunit 138 are coupled to the second I/O subunit 130. In addition, the at least one of portable and wearable computing and communications device 104 comprises a second positioning subunit 140. For example, and in no way limiting the scope of the invention, the second positioning subunit 140 is based on Global Positioning System (GPS).

The second memory subunit 128 comprises a second OS 142. For example, and in no way limiting the scope of the invention, the second OS 142 is a mobile OS. Specifically, the mobile OS 142 is a platform agnostic mobile OS. For instance, the platform agnostic mobile OS 142 is ANDROID™ OS. Further, the second memory subunit 128 comprises an app store 144. Specifically, the app store 144 comprises one or more apps, with corresponding app icons displayed on the second display subunit 138, which apps are available for selective downloading therefrom. Upon downloading and installation of the client-side 152 of the proprietary client-server SOAPSAAS application (app) 146 (not shown here explicitly), the second memory subunit 128 comprises the second OS 142 and the client-side 152 of the proprietary client-server SOAPSAAS application (app) 146, designed and implemented in accordance with the principles of the present invention.

The app store (or app marketplace) 144 facilitates providing a digital distribution platform for mobile apps. The app store 144 facilitates organizing the apps offered thereby based on the following considerations: 1) the function(s) provided by the app (including games, multimedia or productivity), 2) the device for which the app is designed, and 3) the Operating System (OS) on which the app is capable of running. For example, the apps is designed to run on specific devices, and are written for a specific OS, such as IOS®, Mac OS X or OS X®, WINDOWS®, or ANDROID™.

In some embodiments, the app store is available in at least one of an online and offline modality. Specifically, the online app store facilitates users to browse through the different app categories and selectively view information about each app, such as reviews or ratings, and acquire the same, for instance obtain the app in at least one of a predetermined fee and Free of Charge/Cost (FOC). The selected app is downloaded at least one of automatically and manually. For instance, in some scenarios the selected app is offered via an automatic download. Upon downloading, the user installs the downloaded app. In some embodiments, the app store facilitates automatic removal of one or more installed programs or apps from the portable computing and communications devices under certain conditions, with the goal of protecting the user against malicious software.

As depicted in FIG. 1, in some embodiments, the app store 144 comprises the client-side 152 of the proprietary client-server SOAPSAAS application (app) 146, developed and implemented in accordance with the principles of the present invention. As a matter of fact, the second memory subunit 128 comprises the app store 144. Specifically, the app store 144 comprises one or more apps, for instance the client-side 152 of the proprietary client-server SOAPSAAS application (app) 146, with corresponding app icons displayed on the second display subunit 138, which apps are available for use (implementation or execution) upon selective downloading therefrom. More specifically, the second memory subunit 128 comprises the OS 142 and the client-side 152 of the proprietary client-server SOAPSAAS application (app) 146 stored in the second memory subunit 128, upon selective downloading from the app store 144.

In some embodiments involving subscription business models based on Software-As-A-Service (SAAS), the users are provided access to the apps and databases, for instance SAAS-based apps and SAAS-based databases. Cloud providers manage the infrastructure and platforms that run the apps, for instance the server-side and client-side of the app store 144 comprising the server-side 150 and client-side 152 respectively of the proprietary client-server SOAPSAAS application (app) 146, and SAAS-based databases. In some scenarios, the SAAS-based app, for instance the proprietary client-server SOAPSAAS application (app) 146, is referred to as an on-demand or cloud-based software and is priced on a pay-per-use basis. In some scenarios, the SAAS providers fix price of SAAS-based applications, for instance the proprietary client-server SOAPSAAS application (app) 146, using a periodic subscription fee, for instance at least one of an annual, a bi-annual, quarterly and monthly. In some scenarios involving the deployment and implementation of the SAAS-based subscription business model, the cloud providers install and operate apps, for instance the server-side 150 of the proprietary client-server SOAPSAAS application (app) 146, in the cloud, for instance the cloud server, such as the server subsystem 102 comprising the one or more host computing units 108 of FIG. 1, and cloud users access the apps, for instance the client-side 152 of the proprietary client-server SOAPSAAS application (app) 146, from the cloud clients, for instance the at least one of portable and wearable computing and communications devices 104 constituting the client subsystem 104, of FIG. 1. The cloud users are exempted from managing the cloud infrastructure and platform, wherein the apps run, thereby facilitating elimination of the need to install and run the apps on the cloud clients, in turn facilitating simplification of maintenance and support. In some scenarios, the pricing model for the SAAS-based apps is at least one of monthly and yearly flat fee per user, thereby facilitating scalability in terms of price and adjustability in terms of at least one of insertion and deletion of the users.

In some embodiments involving the deployment and implementation of the SAAS-based subscription business models, the SAAS-based app store manifests in the form of an on-demand or a cloud-based app store. In use, the installation and updation of the apps is managed through the cloud-based app store.

In some embodiments, development, deployment and implementation of the proprietary client-server SOAPSAAS application (app) facilitating managing public safety (or security) in one or more situations and methods thereof are disclosed, in accordance with the principles of the present invention. Specifically, the proprietary client-server SOAPSAAS application (app) facilitates managing public safety (or security) in at least one of known, unknown, expected, unexpected, natural, unnatural, wanted, unwanted, just, unjust, timely and untimely situations eventuating anytime, anywhere and anyhow, for instance at least one of danger, untoward incident, accident, emergency, theft, rape, loss and death, with one or more enhanced qualitative and quantitative features, such as minimal vulnerability, fail-safe, fault-tolerance, adaptivity (as-per-need), dynamicity (as-and-when), real-time reminder and notification generation ability as well as automatic evidence manageability, thereby facilitating need-based timely preventive and curative action, on the spot service, near real-time, real-time, in time, on time, Quick Response (QR) or (Just-In-Time or JIT) response, speedy trial, effective prosecution, easy law enforceability and policing, and methods thereof in accordance with the principles of the present invention.

In some embodiments, successful utilization of the proprietary client-server SOAPSAAS application (app) in light of the need for maximal reach of the system and the methods thereof, design and implementation of a proprietary client-server SOA-based SAAS app that is at least one of platform independent, platform-agnostic and cross-platform compatible is disclosed, in accordance with the principles of the present invention. For example, and in no way limiting the scope of the invention, the proprietary client-server SOAPSAAS application (app) 146 is developed to be deployed and implemented across multiple mobile Operating Systems (or mobile OSs), namely ANDROID™, IOS®, WINDOWS®, BB™, and the like. In some embodiments, by virtue of the property of at least one of “platform independence,” “cross-platform compatibility” and “multi-platform compatibility”, the proprietary client-server SOAPSAAS application (app) is implemented and, thus inter-operates on multiple computer platforms, in accordance with the principles of the present invention.

In some embodiments, the cross-platform proprietary client-server SOA-based SAAS app, for instance the proprietary client-server SOAPSAAS application (app) 146 of FIG. 1, is divided into two types. In some scenarios, individual building or compilation is required for each platform that the proprietary client-server SOAPSAAS application (app) 146 is capable of supporting. However, in some scenarios, the proprietary client-server SOAPSAAS application (app) 146 is capable of directly running on any platform without special preparation, for instance the proprietary client-server SOAPSAAS application (app) 146 is written in an interpreted language or pre-compiled portable byte code for which the interpreters or run-time packages are common or standard components of all platforms. For example, a cross-platform application may run on MICROSOFT WINDOWS®, LINUX® on the x86 architecture and Mac OS X or OS X® on either the POWERPC® or x86 based APPLE® MACINTOSH® systems. In some scenarios, the cross-platform proprietary client-server SOAPSAAS application (app) 146 runs on as many as all existing platforms, or on as few as two platforms.

In some scenarios, the users are required or requested to download the client-side 152 of the proprietary client-server SOAPSAAS application (app) 146, of FIG. 1, from at least one of a Direct Download Link (DDL) supplied on the portable computing and communications 104 via clicking the DDL and the app store 144, of FIG. 1, on the portable computing and communications 104 owned by the users via searching for the proprietary client-server SOAPSAAS application (app) 146 in the app store 144 using a suitable mobile browser. In some embodiments, the client-side 152 of the proprietary client-server SOAPSAAS application (app) 146 is bundled or packaged with a portable code that is easily installable and executable by end users, i.e. widget (not shown here explicitly). In use, the widget facilitates exhibiting the current status of the client-side 152 of the proprietary client-server SOAPSAAS application (app) 146 and changing or modifying the current status of the client-side 152 of the proprietary client-server SOAPSAAS application (app) 146 directly from the home page of an On-Device Portal (ODP) (not shown here explicitly).

For example, the widget is a mobile widget. In some embodiments, the mobile widget facilitates maximizing screen space use and is especially useful in placing live data-rich applications, for instance the client-side 152 of the proprietary client-server SOAPSAAS application (app) 146, on the “idle-screen/home-screen/phone-top” of the at least one of portable and wearable computing and communications device 104, of FIG. 1, owned and operated by the user.

In some embodiments involving new users of the client-side of the proprietary client-server SOAPSAAS application (app), upon successfully downloading and installing the client-side of the proprietary client-server SOAPSAAS application (app) the new users are requested or required to at least one of register and sign up therewith, thereby facilitating creation of valid login-credentials therefor, for instance a User Identification (UID or User ID) and Password (PWD) for each of the new users. In some scenarios, each of the new users is requested to key-in at least one of the Mobile Identification Number (MIN), Mobile Subscription Identification Number (MSIN), Subscriber Identification Number (SIN), and a combination thereof, associated with the at least one of portable and wearable computing and communications devices 104, of FIG. 1, owned by each of the new users, as a mandatory requirement. Upon keying in the MIN or MSIN, the MIN or MSIN is subjected to automatic authentication (or verification or validation) via transmission of an SMS to each of the at least one of portable and wearable computing and communications devices 104 owned by each of the new users. In use, the client-side 152 of the proprietary client-server SOAPSAAS application (app) 146 facilitates reading the SMS received on each of the portable computing and communications devices 104 and authenticating or validating the correctness of the MIN or MSIN keyed-in by each of the new users. Upon successful authentication or validation, each of the new users are required or requested to opt and enter a name, PWD, and a master PWD, thereby facilitating completion of the registration or sign up process. In use, the combination of UIDs and PWDs facilitate Authentication, Authorization and Accounting (AAA) of each of the new users. Further, the master PWDs facilitate AAA of other connected devices, which are later inducted into the present system for using the client-side 152 of the proprietary client-server SOAPSAAS application (app) 146.

In use, the client-side 152 of the proprietary client-server SOAPSAAS application (app) 146 is subjected to one (or first) time configuration. Specifically, in use, the user is required or requested to provide or grant permission to the client-side 152 of the proprietary client-server SOAPSAAS application (app) 146 to adaptively (as per need) and dynamically (as and when) access one or more add-on devices of, or associated, integrated or coupled with, the at least one of portable and wearable computing and communications device 104, for instance the sensors, speaker, microphone, Global Positioning System (GPS) and the camera therefor. In some scenarios, the client-side 152 of the proprietary client-server SOAPSAAS application (app) 146 uses the aforementioned add-on devices of, or associated, integrated or coupled with, the portable or wearable computing and communications device 104 upon detection of one or more dangerous situations.

In some embodiments involving initiation of the client-side 152 of the proprietary client-server SOAPSAAS application (app) 146, a user is redirected to the home or index page of at least one of a web portal and an On-Device Portal (ODP) hosted on the server subsystem 102 comprising the one or more host computing units 108, and managed thereby. In some scenarios, the home or index page on the ODP comprises one or more attributes in connection with the proprietary client-server SOAPSAAS application (app), for instance the client-side 152 of the proprietary client-server SOAPSAAS application (app) 146 of FIG. 1, such as the current status, option to change the current status, safe places (or locations) list and trusted group details. For example, by default the current status is preset and marked “ACTIVATED or ACTIVE”. In some scenarios, in the event that the user visits the home or index page for the first time, the user is requested or required to choose and input at least one safe place in the list therefor and at least one trusted member in the list therefor, for instance via inputting a corresponding MIN or MS IN therefor, to add to the list of trusted group.

In use, upon initiating the client-side 152 of the proprietary client-server SOAPSAAS application (app) 146 on the portable or wearable computing and communications device 104, the user is redirected to a home or index page of at least one of a website and an On-Device Portal (ODP) 154 (not shown here explicitly). The website or ODP 154 comprises a Graphics User Interface (GUI) 156 (not shown here explicitly), for instance a Web-based User Interface or Web User Interface (WUI) 156. The GUI 156 displays one or more attributes in connection with the client-side 152 of the proprietary client-server SOAPSAAS application (app) 146, and the user thereof, for instance the status of the client-side 152 of the proprietary client-server SOAPSAAS application (app) 146, the list of safe locations and the trusted group of the user as well as the profile of the user. Specifically, the GUI 156 provides one or more graphic control elements or widgets for managing, or corresponding to, the one or more attributes in connection with the client-side 152 of the proprietary client-server SOAPSAAS application (app) 146, and the user thereof, thereby facilitating at least one of inserting new values, selecting, deselecting, deleting and modifying (or editing) the existing values corresponding to the one or more attributes in connection with the client-side 152 of the proprietary client-server SOAPSAAS application (app) 146, and the user thereof. For example, and in no way limiting the scope of the invention, the status of the client-side 152 of the proprietary client-server SOAPSAAS application (app) 146 is at least one of selected, deselected, set, reset and modified by a user via at least one of a radio button, drop-down list and combo box, provided in the GUI 156. Likewise, the list of safe locations is at least one of 1) newly generated in entirety, and 2) modified at least one of in part and in entirety, via at least one of A) selecting (or reselecting), B) deselecting, C) deleting, D) editing the existing items (or elements or entries) thereof at least one of in part and in entirety and E) inserting at least one of in part and in entirety new items by a user via at least one of i) selecting and deselecting existing options representing one or more existing safe locations in turn juxtaposed corresponding to one or more checkboxes, ii) selecting and deselecting existing items representing one or more existing safe locations in a list box, iii) deleting, editing existing entries representing one or more existing safe locations, inserting new entries representing one or more new safe locations in a combo box and selecting one new entry at one point in time, any of the foregoing or all provided in the GUI 156. Still likewise, the trusted group and members thereof is at least one of 1) newly generated in entirety, and 2) modified at least one of in part and in entirety, via at least one of A) deleting, B) selecting, C) deselecting, D) editing at least one of in part and in entirety the existing items (or elements or entries) thereof and E) inserting at least one of in part and in entirety new items by a user via at least one of i) selecting and deselecting existing options representing one or more existing members of the trusted group in turn juxtaposed corresponding to one or more checkboxes, ii) selecting and deselecting existing items representing one or more existing members of the trusted group in a list box, iii) deleting, editing existing entries representing existing members of the trusted group and inserting new entries representing one or more new members in a combo box, and selecting one new entry at one point in time, any of the foregoing or all provided in the GUI 156.

In some scenarios, the default status of the client-side 152 of the proprietary client-server SOAPSAAS application (app) 146 is set as at least one of “ACTIVE” and “ACTIVATED”. For example, and in no way limiting the scope of the invention, in some embodiments involving ANDROID TM based client-server SOA-based SAAS app, for instance the client-side 152 of the proprietary client-server SOAPSAAS application (app) 146, the users are at least one of requested and allowed to move the widget or graphical control element for controlling the status of the client-side 152 of the proprietary client-server SOAPSAAS application (app) 146 to the home page, thereby facilitating one click alteration in the status of the client-side 152 of the proprietary client-server SOAPSAAS application (app) 146, for purposes of ease of access or expediency.

In some scenarios involving first time or new users or visitors to the home or index page, the first time visitors (or users) are requested to at least one of build and identify via at least one of inserting new and selecting existent safe locations, if any, correspondingly, and set safe locations, thereby facilitating at least one of generation and realization of a list of safe locations, in that order. For example, the list of safe locations is at least one of created and modified by a user via using at least one of checkboxes, list box, combo box and drop-down list provided in the GUI 156. Likewise, the first time visitors (or users) are requested to at least one of build and identify via at least one of inserting new and selecting existent mobile numbers of trusted people, if any, correspondingly, and set list of mobile numbers of trusted people, for instance family members, social media contacts, friends, relatives, colleagues, doctors, lawyers, policemen, politicians, and the like, thereby facilitating at least one of generation and realization of a trusted group list. The list for trusted group is at least one of created and modified by a user via at least one of checkboxes, list box, combo box and drop-down list provided in the GUI 156. In some embodiments involving each visit of the user on the home or index page, the client-side 152 of the proprietary client-server SOAPSAAS application (app) 146 performs a check to determine whether or not at least one safe location has been, or is, opted. In some scenarios, in the event that the user at least one of intentionally and unintentionally fails or failed to opt the at least one safe location, the user is prompted to choose at least one safe location. However, in some embodiments, the selection or choice of the at least one safe location is not a roadblock. For example, and in no way limiting the scope of the invention, in some scenarios, in the event that the user at least one of intentionally and unintentionally chose or opted less than Three (3) contacts in the trusted group, the client-side 152 of the proprietary client-server SOAPSAAS application (app) 146 prompts the user to save a few additional mobile numbers in the trusted group in order to take the maximum benefit of the client-side 152 of the proprietary client-server SOAPSAAS application (app) 146 in case of any danger.

In use, upon arrival of a user to the home page, the client-side 152 of the proprietary client-server SOAPSAAS application (app) 146 determines whether or not the user has selected at least one safe location in or from the list of safe locations. In the event that the user failed to select the at least one safe location, the user is prompted to at least one of insert a new and select an existent location, and set the same as at least one safe location. However, in some embodiments, the at least one of insertion of new and selection of existent at least one safe location is not a blockade. In some scenarios, in the event that a user is found to have at least one of inserted and selected, and set at least Three (3) mobile numbers, the user is prompted or advised to at least one of insert and select, and set at least Two (2) additional mobile numbers in the trusted group in order to exploit maximum benefit from the client-side 152 of the proprietary client-server SOAPSAAS application (app) 146 in cases of any dangers.

As used in the current context, the term “safe places or locations” refers to one or more places or locations in one or more safe zones or regions, wherein the users at least one of remained safe or felt safe in the past (past threat perception), feels (or are) safe or is safe in the present (present threat perception), may remain or feel safe in the future (future threat perception) and a combination thereof, based on at least one of self-assessments, family-assessments, expert-assessments, peer-assessments, colleague-assessments, news and public (or government) assessments of the aforementioned one or more places or locations in the one or more safe zones or regions. For example, the one or more places or locations are confined to one or more safe zones or regions, for instance at least one of homes, offices, government buildings, police stations, courts, sea beaches, harbors, seaports, airports, stadiums, museums, zoos, public parks, railway stations, theatres, malls, schools, colleges, universities, libraries, hospitals and the like.

In some scenarios, a user at least one of inserts new and selects existent mobile numbers, if any, and performs a combination of activities thereof, thereby facilitating populating the trusted group list to a predefined maximum, for instance Ten (10) mobile numbers corresponding to the members thereof. In some scenarios, the user is permitted to populate the trusted group list with mobile numbers via at least one of selecting from the existing contacts list and entering directly. In some scenarios, the users are permitted to at least one of insert and modify the names of members in the trusted group list. In some scenarios, the user is permitted to assign priority to the members in the trusted group list, thereby facilitating reordering the trusted group list based on the assigned priority. In some scenarios involving occurrence of at least one of unknown, unexpected, unwanted and untimely events or incidents, the priority assigned to the members in the trusted group list is considered during dialing or calling the members in the trusted group list.

In some scenarios involving occurrence of at least one of unknown, unexpected, unwanted and untimely events or incidents, a Short Message Service (SMS) is at least one of anycasted, unicasted, geocasted, broadcasted and multi-casted to all the members (or intended recipients) in the trusted group list. Specifically, the broadcasted or multi-casted SMS comprises the name, current location, and mobile number of a sender, who added the members (or intended recipients) in the trusted group list. More specifically, the broadcasted or multi-casted SMS comprises a common Direct Download Link (DDL) to an app store, for instance the app store 144. The broadcasted or multi-casted SMS requests the user to download the proprietary client-server SOAPSAAS application (app) 146 from the DDL. In use, upon clicking the DDL, the platform of the destination portable or wearable computing and communications device 104 is detected. Upon detection, the user is redirected to the home page of the app store 144 to download the proprietary client-server SOAPSAAS application (app) 146.

In some scenarios, the members in the trusted group list, who are recipients of the broadcasted or multi-casted SMS are advised to download the proprietary client-server SOAPSAAS application (app) 146 in order to utilize all the features of the proprietary client-server SOAPSAAS application (app) 146, thus maximizing the chances or probability of helping the person, i.e. a sender, in at least one of unknown, unexpected, unwanted and untimely situations.

In some embodiments, automatic activation of the client-side of the proprietary client-server SOAPSAAS application (app) based on the current position of a user relative to the selected safe locations is disclosed, in accordance with the principles of the present invention. Specifically, in use, the current position of the user relative to the selected safe locations is detected via tracking the movement, i.e. change(s) in position(s), of the user with respect to time in the selected safe locations. In some scenarios, in the event that the current position of the user is detected outside at least one of the selected safe locations, the client-side 152 of the proprietary client-server SOAPSAAS application (app) 146 is automatically activated. Specifically, in use, in the event that the current position of the user at any given point in time is detected at least one of outside and exceeding a predetermined distance, for instance defined by the radius of an imaginary quasi-circle, encompassing any of the selected safe locations, with the center therefor equidistant from the points on the circumference therefor, the client-side 152 of the proprietary client-server SOAPSAAS application (app) 146 is automatically activated. For example, and in no way limiting the scope of the invention, in the event that the user moves outside at least a 10 m radius of an imaginary quasi-circle encompassing any of the selected safe locations, the client-side 152 of the proprietary client-server SOAPSAAS application (app) 146 is automatically activated. Of note here is that fact that the selection of exact coordinates of a safe location is crucial, thereby facilitating ensuring higher accuracy and requisite functioning of the client-side 152 of the proprietary client-server SOAPSAAS application (app) 146. In some exemplary embodiments, the user is recommended to select a safe location upon physical presence of the user at the selected location followed by detection and selection of the current coordinates of the selected location of presence.

As used in general, the term “web mapping” refers to the process of using maps delivered by Geographical Information Systems (GISs). Since a web map on the World Wide Web (WWW) is both served and consumed, web mapping is more than just web cartography, as web mapping is both a service (or service provider-initiated) activity and consumption (or consumer-initiated) activity. Web GIS emphasizes geodata processing aspects more involved with design aspects, such as data acquisition and server software architecture, such as data storage and algorithms, rather than the end-user reports. The terms web GIS and web mapping remain somewhat synonymous. Web GIS uses web maps, and end users, who are web mapping are gaining analytical capabilities. The term location-based services refer to web mapping consumer goods and services. Web mapping usually involves a web browser or other user agent capable of client-server interactions.

In some embodiments, GIS maps are used for loading the coordinates of the safe locations in order to ensure that the locations are accurate. In some scenarios, upon selection of a given location by a user to save or store as a safe location, the GIS map exhibits to the user the current location thereof. In some scenarios, the user at least one of saves the current location as the safe location and uses the client-side 152 of the proprietary client-server SOAPSAAS application (app) 146 to navigate and choose some other location as a safe location. In some embodiments, the client-side 152 of the proprietary client-server SOAPSAAS application (app) 146 renders proper guidance and recommendations therefor to the user in proper selection of one or more locations as the safe locations with exact position coordinates therefor.

In some scenarios, in the event that the user fails (or failed) to at least one of intentionally and unintentionally select and set any location as the safe location, the client-side 152 of the proprietary client-server SOAPSAAS application (app) 146 checks the instant or current location of the user, wherein the user is not moving, or has not moved, for more than at least a predefined period of time, for instance 8 hours. In some scenarios, in the event that the user is not moving, or has not moved, in the instant location for more than at least the predefined period of time, a notification is generated and transmitted to the user to verify whether or not the instant location is safe enough to be added to the safe location list. In some scenarios, in the event that the user confirms a mid area in the instant location is safe, the instant location is automatically saved as the safe location for the user. In some scenarios, the aforementioned process in connection with identification, analysis, selection and definition (determination) of a safe location is repeated or extended to all the cases in which the user has already saved a safe location, however the user is still desirous of saving additional locations as the safe locations in the list of safe locations.

In some embodiments, integration of the IT systems with (or using) key landmarks in the geographic areas is disclosed, in accordance with the principles of the present invention. In some scenarios, one or more public authorities in the geographic areas in at least one of proximity and vicinity of the key landmarks therein facilitate providing timely help to the victims. For instance, one or more key landmarks like malls, hospitals, commercial buildings, hotels and the rest are used. The client-side 152 of the proprietary client-server SOAPSAAS application (app) 146 is installed in at least one of the portable and wearable computing and communications devices 104, which is present in the location. The person(s) reaching out for help carry the portable or wearable computing and communications devices, for instance the wearable computing device 104, for the purpose.

In some scenarios, initial strategic tie-ups with law enforcement agencies, such as religious law enforcement, internal affairs, police, military law enforcement, private law enforcement, and the like, is done or executed in crime prone areas of the cities.

In some embodiments, deployment and implementation of the client-side 152 of the proprietary client-server SOAPSAAS application (app) 146 facilitates realization of a social network comprising the trusted group of a given user, wherein the members of the trusted group of the user are considered as the first level connection(s), and wherein the connected or linked users or contacts in the trusted groups of the first level connection(s) are considered as the second level connection(s), and so on.

In some embodiments, deployment and implementation of the proprietary client-server SOAPSAAS application (app) as a software extension to existing social media is disclosed, in accordance with the principles of the present invention. In use, the deployment and implementation of the proprietary client-server SOAPSAAS application (app) 146 as a software extension to existing social media facilitates timely help during occurrence of at least one of unknown, unexpected, unwanted and untimely events or incidents, as well as promoting the proprietary client-server SOAPSAAS application (app) 146. In use, the client-side 152 of the proprietary client-server SOAPSAAS application (app) 146 is subjected to one time authentication and authorization conducted by each of the social media entities the user wishes to integrate the client-side 152 of proprietary client-server SOAPSAAS application (app) 146.

In some embodiments, implementation of multiple modes of operation of the proprietary client-server SOAPSAAS application (app) is disclosed, in accordance with the principles of the present invention. Specifically, the client-side 152 of proprietary client-server SOAPSAAS application (app) 146 facilitates a user to select at least one of a plurality of distinct modes of operation of the client-side 152 of proprietary client-server SOAPSAAS application (app) 146 based on the applicability (or suitability) of the client-side 152 of proprietary client-server SOAPSAAS application (app) 146 in at least one of unknown, unexpected, unwanted and untimely situations, and the level of severity involved thereof, and the kind of security required therefor. For example, the client-side 152 of proprietary client-server SOAPSAAS application (app) 146 facilitates the user to at least one of select anyone of and switch between the distinct modes of operation. For purposes of clarity and expediency, the one or more distinct modes of operation are hereinafter referred to as “CONTINUOUSLY ACTIVE (OR DEFAULT),” “USER-INITIATED (OR -ACTIVATED)” and “CONTEXT-AWARE” based on the level of severity involved, and the kind of security required therefor. In some scenarios involving the CONTINUOUSLY ACTIVE mode, the client-side 152 of proprietary client-server SOAPSAAS application (app) 146 facilitates at least one of automatic, autonomous and a combination thereof, continuous tracking of the user by detecting the position of the user with respect to time, relative to the safe locations, for instance at least one of inside and outside the safe locations.

In some scenarios involving the CONTINUOUSLY ACTIVE mode, the client-side 152 of proprietary client-server SOAPSAAS application (app) 146 facilitates at least one of automatic, autonomous and a combination thereof, continuous detection of the user by tracking the change in the position of the user with respect to time, relative to the safe locations. Alternatively, in some scenarios involving the USER-INITIATED (OR -ACTIVATED) mode, the client-side 152 of proprietary client-server SOAPSAAS application (app) 146 facilitates user-initiated automatic tracking of the user by detecting the position of the user with respect to time, relative to the safe locations. Likewise, in some scenarios involving the USER-INITIATED (OR -ACTIVATED) mode, the client-side 152 of proprietary client-server SOAPSAAS application (app) 146 facilitates user-initiated automatic detection of the user by tracking the change in the position of the user with respect to time, relative to the safe locations. In some scenarios involving the CONTEXT-AWARE mode, the client-side 152 of proprietary client-server SOAPSAAS application (app) 146 facilitates context-initiated (or triggered) automatic tracking of the user by detecting the position of the user with respect to time, relative to the safe locations and the context thereof. Likewise, in some scenarios involving the CONTEXT-AWARE mode, the client-side 152 of proprietary client-server SOAPSAAS application (app) 146 facilitates context-initiated (or triggered) automatic user detection and tracking, i.e. user detection by tracking and user tracking by detection, based on the overall context including, but not limited to, the position of the user with respect to time, relative to the safe locations. In some scenarios involving the TIME-SENSITIVE (OR -DEPENDENT) mode, the client-side 152 of proprietary client-server SOAPSAAS application (app) 146 facilitates time-delay initiated (or -triggered) automatic user detection and tracking, i.e. user detection by tracking and user tracking by detection, based on the time delay (or latency) in movement state of the user relative to a given position in a given location, irrespective of whether or not the user is confined to the safe locations. In some scenarios involving at least one of the CONTINUOUSLY ACTIVE mode, USER-INITIATED (OR -ACTIVATED) mode, CONTEXT-AWARE mode and TIME-SENSITIVE (OR -DEPENDENT) mode, the client-side 152 of proprietary client-server SOAPSAAS application (app) 146 facilitates at least one of fail-safe, fail-secure and fault-tolerant operation of the at least one of the portable and wearable computing and communications devices 104. In some scenarios, in the event that the user at least one of feels safe and anticipates safety, the client-side 152 of proprietary client-server SOAPSAAS application (app) 146 facilitates switching from the CONTINUOUSLY ACTIVE to at least one of the USER-INITIATED (OR -ACTIVATED) mode, CONTEXT-AWARE mode and TIME-SENSITIVE (OR -DEPENDENT) mode. Alternatively, in some scenarios, in the event that the user fails to feel safe in the saved safe locations based on at least one of anticipation, intuition, recommendation and guesstimation, the client-side 152 of proprietary client-server SOAPSAAS application (app) 146 facilitates switching from the current mode to the to at least one of the USER-INITIATED (OR -ACTIVATED) mode, CONTEXT-AWARE mode and TIME-SENSITIVE (OR -DEPENDENT) mode.

In some optional embodiments, the implementation of an addendum mode of operation of the proprietary client-server SOAPSAAS application (app) is disclosed, in accordance with the principles of the present invention. For purposes of clarity and expediency, the addendum mode of operation is hereinafter referred to as “TRAINING AND LEARNING” mode. In use, in the TRAINING AND LEARNING mode, the client-side 152 of proprietary client-server SOAPSAAS application (app) 146 is at least one of automatically and partially manually subjected to training and learning to capture and recognize at least one of the actual voice, image, usage or behaviour pattern of the user, and the . In some embodiments involving the TRAINING AND LEARNING mode, the client-side 152 of proprietary client-server SOAPSAAS application (app) 146 facilitates capturing at least one of responses to at least one of objective and subjective questionnaire, image (or visual), video, audio, multimedia and voice of the user, analyzing the captured data or information, profiling the user based partly on the captured information and partly on the usage behaviour and history of the user, categorizing the user relative to other users of the client-side 152 of proprietary client-server SOAPSAAS application (app) 146 in the first, second level connection(s) and so on one or more social media and recommending the user in identification, analysis and selection of one or more most optimal safe locations and contacts in the trusted group.

In some embodiments, all ins-and-outs in connection with the implementation of the multiple operation mode (or multi-mode) feature of the proprietary client-server SOAPSAAS application (app) are disclosed, in accordance with the principles of the present invention. Reiterating again, the client-side 152 of proprietary client-server SOAPSAAS application (app) 146 facilitates the user to at least one of select anyone of and switch between the distinct modes of operation. For purposes of clarity and expediency, the one or more distinct modes of operation are hereinafter referred to as “CONTINUOUSLY ACTIVE,” “USER-INITIATED (OR -ACTIVATED),” “CONTEXT-AWARE” and “TIME-SENSITIVE (OR -DEPENDENT)” based on the level of severity involved thereof and security required therefor. The aforementioned distinct modes of operation facilitate definition of (or defining) the status of the client-side 152 of proprietary client-server SOAPSAAS application (app) 146. As mentioned earlier, in use, the widget facilitates exhibiting the status of the client-side 152 of proprietary client-server SOAPSAAS application (app) 146 and changing or modifying the status of the client-side 152 of proprietary client-server SOAPSAAS application (app) 146 directly from the home page of the ODP.

In some scenarios involving the CONTINUOUSLY ACTIVE mode, the client-side 152 of proprietary client-server SOAPSAAS application (app) 146 facilitates dynamic tracking of the user by detecting the position of the user outside the safe locations. In use, the safe location (or area) in connection with a given selected safe zone (or region) is calculated as the area confined in a 10 m radius of an imaginary quasi-circle encompassing the given selected safe location. Further, in use, during tracking the user the client-side 152 of proprietary client-server SOAPSAAS application (app) 146 facilitates capturing and recognizing one or more pre-defined keywords spoken or uttered by the user. In some scenarios, in the event that the pre-defined keywords are spoken by the user, the client-side 152 of proprietary client-server SOAPSAAS application (app) 146 facilitates identifying at least one of unknown, unexpected, unwanted and untimely situations and, in turn, facilitates implementation of one or more sequences of steps based on the situation detection and management process, designed and implemented in accordance with the principles of the present invention.

In some scenarios involving the USER-INITIATED (OR -ACTIVATED) mode, the client-side 152 of proprietary client-server SOAPSAAS application (app) 146 is deactivated, and thus does not facilitate at least one of automatic, autonomous and a combination thereof, user detection and tracking. In use in the USER-INITIATED (OR -ACTIVATED) mode, the client-side 152 of proprietary client-server SOAPSAAS application (app) 146 fails to facilitate recognizing the pre-defined keywords spoken by the user, hence the at least one of unknown, unexpected, unwanted and untimely situations is not detected.

In some scenarios involving significant movement of the user in the USER-INITIATED (OR -ACTIVATED) mode, the client-side 152 of proprietary client-server SOAPSAAS application (app) 146 facilitates notifying the user to activate the client-side 152 of proprietary client-server SOAPSAAS application (app) 146. In some scenarios involving the USER-INITIATED (OR -ACTIVATED) mode of the client-side 152 of proprietary client-server SOAPSAAS application (app) 146 owing to at least one of intentional and unintentional act of the user resulting in at least one of selection of and switching to the USER-INITIATED (OR -ACTIVATED) mode, the client-side 152 of proprietary client-server SOAPSAAS application (app) 146 facilitates notifying the user to activate the same, whereas prompting the user to ignore or disregard the notification in the event that the client-side 152 of proprietary client-server SOAPSAAS application (app) 146 is in at least one of the CONTEXT-AWARE and TIME-SENSITIVE (OR -DEPENDENT) modes.

In some scenarios involving the FAILSAFE mode, the client-side 152 of proprietary client-server SOAPSAAS application (app) 146 is activated in the safe locations in which the user may or may not feel safe at any point in time based on assessments therefor using at least one of anticipation, intuition and guesstimation of the user, and the peers thereof. For example, and in no way limiting the scope of the invention, a marital female saves the home as one of the safe locations. However, in the event that the spouse of the marital female may be out of the home on an official trip, the marital female may or may not feel safe at home.

In some embodiments, customized configuration for the Power Management Integrated Circuits (Power Management ICs or PMICs) and wire routing in the design of Printed Circuit Boards (PCBs) in connection with the at least one of portable and wearable computing and communications device is disclosed, in accordance with the principles of the present invention. Specifically, in use, the at least one of portable and wearable computing and communications device is designed in a manner such that upon powering “ON”, the at least one of portable and wearable computing and communications device goes into deep sleep mode, wherein the microphone of the at least one of portable and wearable computing and communications device is in at least one of an “ON” state and a wait state pending at least one of a button (key) press interrupt, touch interrupt and external device interrupt. Further, in use, upon reception of the aforementioned interrupts by at least one of a Central Processing Unit (CPU) or Microprocessor Unit (MPU), i.e. the second microprocessor subunit 126 of FIG. 1, and the Power IC (not shown here explicitly) specific sequence of instructions based on the type of interrupt or command are executed.

In some embodiments, the at least one of portable and wearable computing and communications devices are designed to be implemented in, via at least one of autonomous automatic and manual selection of, at least one of predefined implicit and user-defined explicit operation modes based on at least one of selective activation, deactivation, and a combination thereof, of one or more add-on components thereof. For instance, the one or more add-on components are at least one of an imaging device, a GPS sensor (receiver), GSM unit, one or more additional sensors, one or more auxiliary wireless communication units and one or more auxiliary positioning units. Specifically, the one or more user-defined explicit operation modes based on at least one of selective activation, deactivation and a combination thereof of one or more add-on components thereof are at least one of mapped and correspond to one or more potential real-time use case scenarios in connection with the at least one of unknown, unexpected, unwanted and untimely situations. For instance, one or more real-time use case scenarios in connection with the at least one of unknown, unexpected, unwanted and untimely situations require use of at least one of a microphone, imaging device and a combination thereof based on the level of severity, and the kind of security required therefor.

In some embodiments, the at least one of portable and wearable computing and communications devices are designed to be implemented in, via at least one of autonomous automatic and partially manual selection of, at least one of predefined implicit and user-defined explicit operation modes correspondingly based on at least one of selective failover and selective switchover to one or more redundant or standby wireless networks upon at least one of failure, unavailability and timeout.

In some scenarios involving unsafe or insecure locations or context, at least one of women, children, teenager girls and veterans (elderly) are at least one of prone (or susceptible) to and subjected (or exposed) to one or more forms of sexual abuse, such as commercial sexual exploitation, pornography, prostitution, sex tourism, forced prostitution, genital modification and mutilation, rape, raptio, sexual assault, sexual bullying, sexual harassment, sexual misconduct, sexual slavery, sexual violence, obscene gestures, such as a-ok, anasyrma, bras d'honneur, cornuto, fig sign, finger, mooning, mountza, shocker and wanker, and elder abuse, such as physical, psychological/emotional, financial abuse, scam by strangers, sexual, neglect and Hybrid Financial Exploitation (HFE), abandonment, rights abuse, self-neglect, institutional abuse, financial exploitation, and the like.

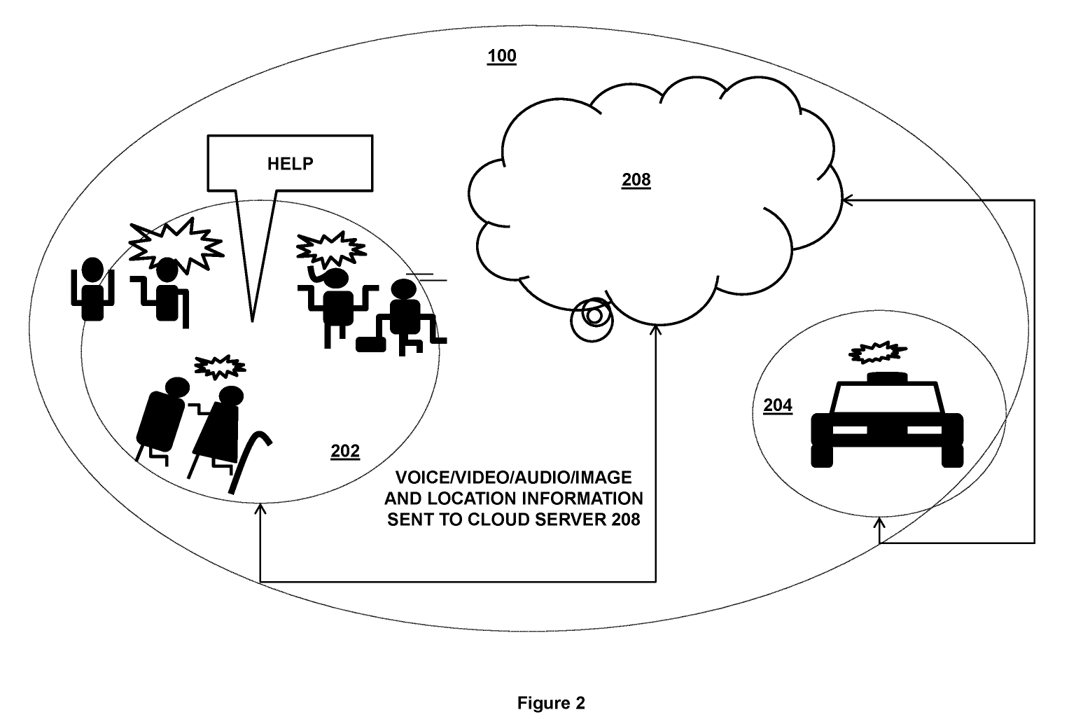

FIG. 2 depicts a first exemplary pictorial representation in connection with implementation of the system 100, of FIG. 1 and method thereof, in at least one of unknown, unexpected, unwanted and untimely situations, according to one or more embodiments.

As depicted in FIG. 2, the system 100 comprises A) a first set of source locations 202 comprising one or more sites or locations or Physical Points of Presence (POP) of human subjects or targets or places of occurrence of at least one of unknown, unexpected, unwanted and untimely situations to which the human subjects or targets are at least one of party, witness, exposed, subjected, prone and susceptible to, for instance a crime scene, B) a control room subsystem 204 comprising one or more metropolitan police or special security jurisdictions control rooms, for instance at least one of a stationery Police Control Room (PCR) and mobile PCR vehicle, C) a second set of destination locations 206 (not shown here explicitly) comprising one or more sites or locations or places or Physical Points of Presence (POP) of at least one of family members, social media contacts, peers, friends, relatives, colleagues, doctors, lawyers, policemen, politicians, and the like, of the human subjects or targets, D) a cloud-based sever subsystem 208, E) one or more portable or wearable computing and communications devices 104, of FIG. 1, owned and operated by the human subjects or targets, for instance at least one of women, children, teenager girls and veterans (elderly) at least one of prone (or susceptible) to and subjected (or exposed) to one or more forms of sexual and elder abuse and F) one or more portable computing and communications devices 104 (not shown here explicitly), of FIG. 1, owned and operated by the at least one of PCR, mobile PCR vehicle and the at least one of family members, friends, relatives, colleagues, doctors, lawyers, policemen, politicians, and the like.

In some scenarios in the event that at least one of a woman, child, teenager girl and veteran (elderly), i.e. a user, are exposed to one or more forms of sexual and elder abuse in at least one of unknown, unexpected, unwanted and untimely situations, in use the user shouts and utters one or more pre-defined keywords, such as “HELP”. A proprietary app, for instance the client-side 152 of the proprietary client-server SOAPSAAS application (app) 146 of FIG. 1, facilitates identification of the pre-defined keywords uttered by the user as an indication of at least one of unknown, unexpected, unwanted and untimely situations. The client-side 152 of the proprietary client-server SOAPSAAS application (app) 146 facilitates sending a SOS with the location of the portable or wearable computing and communications device, for instance the wearable computing device 104, running the client-side 152 of the proprietary client-server SOAPSAAS application (app) 146 plus at least one of captured image, audio, voice, video and a combination thereof information to the cloud-based server subsystem 208. In some scenarios, the user dials one or more emergency telephone numbers, such as 000 (Australia), 108 (India), 111 (New Zealand), 112 (EU and various others), 117 (Philippines), 119 (parts of Asia and Jamaica), 911, (E-911) (North America) and 999 (UK and various others). In addition, the user dials one or more telephone numbers in the list of trusted group, for instance the one or more portable computing and communications devices 104 owned and operated by the at least one of PCR, mobile PCR vehicle and the at least one of family members, friends, relatives, colleagues, doctors, lawyers, policemen, politicians, and the like. The portable computing and communications (or wearable computing device) 104 facilitates at least one of sequentially, randomly and selectively capturing at least one of audio, visual, video and a combination thereof at each predetermined time interval (or period). In some embodiments, the randomly captured at least one of audio, visual, video and a combination thereof at each predetermined time interval serves as evidence in connection with at least one of unknown, unexpected, unwanted and untimely situations.

In operation, upon reception of the SOS signal from the portable computing and communications (or wearable) device 104 of a user, the cloud-based server subsystem 208 facilitates notifying a control room, for instance a Police Control Room (PCR), Neighborhood Policing Team (NPT) or Safer Neighborhood Team (SNT), Emergency Control Centre or Emergency Communications Centre (ECC), in at least one of proximity and vicinity of the portable computing and communications (or wearable) device 104 of the user. In addition, the cloud-based server subsystem 208 facilitates notifying one or more members in the list of trusted group owning and operating the portable computing and communications device 104. The proprietary client-server SOAPSAAS application (app) 146 starts recording or capturing at least one of audio, visual, image, video, voice and a combination thereof, which are streamed to the cloud-based server subsystem 208, PCR Wide Area Network (WAN) and in the proprietary client-server SOAPSAAS application (app) 146 of the trusted group. The proprietary client-server SOAPSAAS application (app) 146 also captures random images, which are used as legal evidence in the case of crime.

In some embodiments, the system is capable of facilitating implementation of complex event processing techniques, according to the principles of the present invention.

In general, event processing is a method of tracking and analyzing (processing) streams of information (data) about things that happen (events), and deriving conclusions therefrom. Specifically, complex event processing is event processing that combines data from multiple sources to infer events or patterns that suggest more complicated circumstances. The goal of complex event processing is to identify meaningful events, for instance opportunities or threats, and respond to the events as quickly as possible.

In some exemplary embodiments involving organizations and related activities thereof, one or more events occur across the various layers of an organization, for instance sales leads, orders or customer service calls. In some scenarios, the events are at least one of news items, text messages, social media posts, stock market feeds, traffic reports, weather reports and other kinds of data. An event is also be defined as a “change of state,” when a measurement exceeds a predefined threshold of time, temperature, or other value.

In some exemplary embodiments involving conceptual description of complex event processing, amidst thousands of incoming events, a given monitoring system for instance receives following three events from the same source, namely 1) church bells ringing, 2) the appearance of a man in a tuxedo with a woman in a flowing white gown and 3) rice flying through the air. From the events listed above, the given monitoring system infers a complex event, for instance a wedding. Thus, complex event processing as a technique helps discover complex events by analyzing and correlating other events, for instance the ringing of the bells, the appearance of the man and woman in wedding attire and the rice flying through the air. As a general rule, complex event processing relies on a number of techniques including but not limited to, event-pattern detection, event abstraction, event filtering, event aggregation and transformation, modeling event hierarchies, detecting relationships, such as at least one of causality, membership and timing, between events and abstracting event-driven processes.

In some embodiments, the system comprises at least one of a portable and wearable computing and communications device equipped with one of more sensors. For example, the types of sensors includes: an acoustic sensor, a sound sensor, a vibration sensor, a chemical sensor, an electric current sensor, an electric potential sensor, a magnetic sensor, a radio sensor, an environment sensor, a weather sensor, a moisture sensor, a humidity sensor, a position sensor, an angle sensor, a displacement sensor, a distance sensor, a speed sensor, an accelerometer, an optical sensor, a light sensor, an imaging sensor, a photon sensor, a pressure sensor, a thermal sensor, a heat sensor, a temperature sensor, a proximity sensor, and/or a presence sensor.

In some scenarios involving use of the wearable computing device 104, of FIG. 1, worn by children travelling in a school bus, the pressure sensor integrated with the wearable computing device 104 facilitates sensing or capturing the change in the air pressure in the event that the children put the hands outside the school bus. The change in the air pressure is used to generate an alarm for the driver or attendant in the school bus.

In some scenarios involving use of the wearable computing device 104 worn by children at least one of under supervision of, in the company of and under illegal custody of at least one of a known attendant and an unknown person, the imaging sensor integrated with the wearable computing device 104 facilitates sensing or capturing the at least one of video and visuals of the at least one of the known attendant and unknown person and suspicious activities, if any, made thereby.

In some scenarios the at least one of portable and wearable computing and communications device 104 facilitates at least one of people tracking by detection and people detection by tracking.

In some embodiments, deployment of one or more Unmanned Aerial Vehicles (UAVs) for managing public safety in at least one of unknown, unexpected, unwanted and untimely situations is disclosed, in accordance with the principles of the present invention. For example, and in no way limiting the scope of the invention, the UAV is at least one of a drone, an Unpiloted Aerial Vehicle (UAV), a Remotely Piloted Aircraft (RPA), Micro Air Vehicle (MAV), Micro Aerial Vehicle (MAV), miniature UAV, Small UAV (SUAV), Radio-Controlled (RC) aircraft, RC plane, quadcopter and the like.

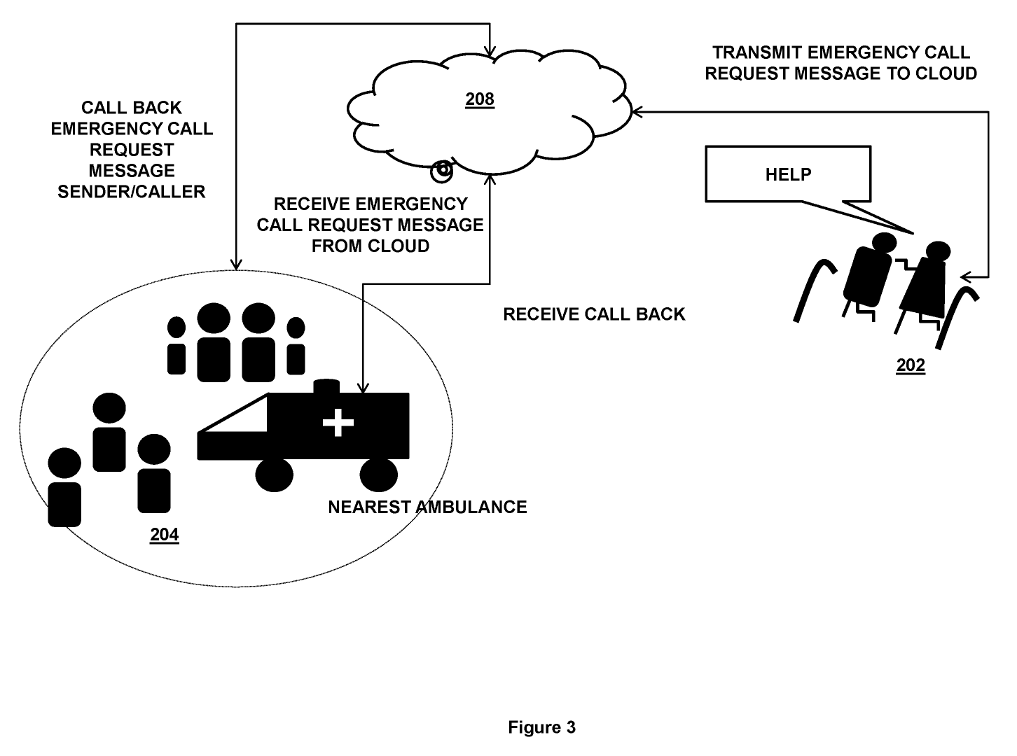

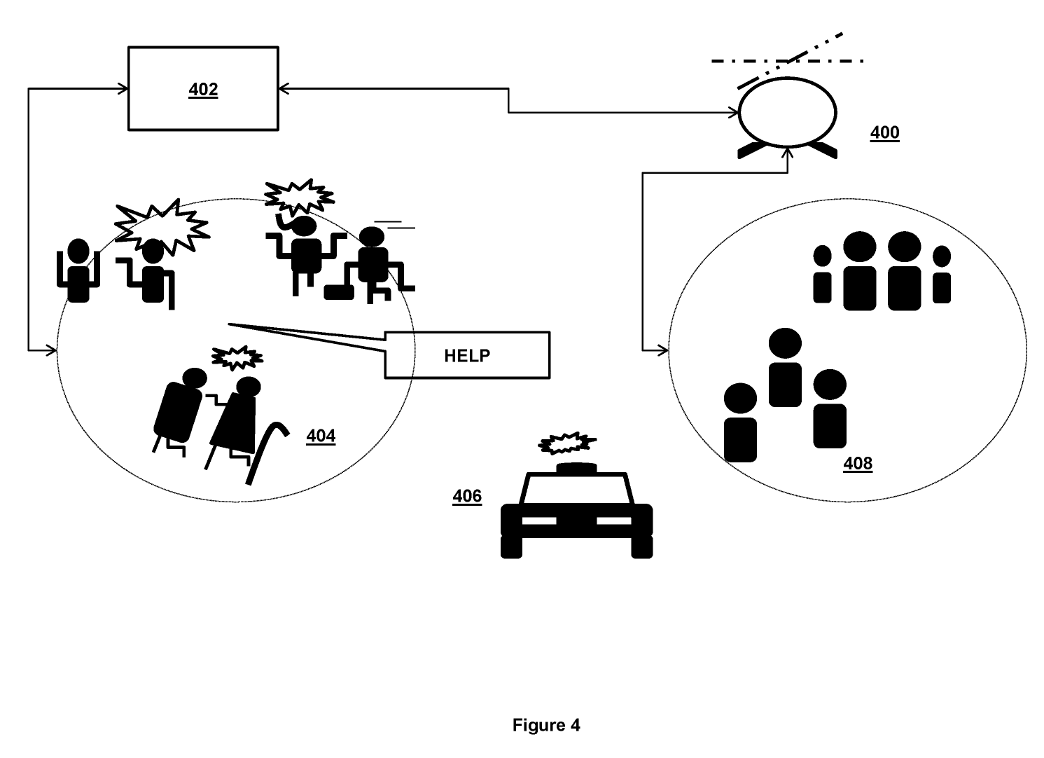

FIG. 3 depicts a second exemplary pictorial representation in connection with implementation of the system 100, of FIG. 1 and method thereof, in one or more potentially dangerous situations, according to one or more embodiments.

FIG. 4 depicts a third exemplary pictorial representation in connection with implementation of the system 100, of FIG. 1 and method thereof, in one or more potentially dangerous situations, according to one or more embodiments.

As depicted in FIG. 4, the system 100 comprises A) a UAV 400, B) a zonal control centre 402, C) a set of source locations 404 comprising Physical Points of Presence (POP) of human subjects or targets in one or more sites or locations or places occurrence of at least one of unknown, unexpected, unwanted and untimely situations to which the human subjects or targets are at least one of exposed, subjected, prone and susceptible to, for instance a crime scene, D) a control room subsystem 406 comprising one or more metropolitan police or special security jurisdictions control rooms, for instance at least one of a Police Control Room (PCR) and mobile PCR vehicle, E) a set of destination locations 408 comprising one of more sites or locations or places or Physical Points of Presence (POP) of at least one of family members, friends, relatives, colleagues, doctors, lawyers, policemen, politicians, and the like, of the human subjects or targets, one or more wearable computing devices 104, of FIG. 1, owned and operated by the at least one of women, children, teenager girls and veterans (elderly) at least one of prone (or susceptible) to and subjected (or exposed) to one or more forms of sexual abuse and F) one or more portable computing and communications devices 104 owned and operated by the at least one of PCR, mobile PCR vehicle and the at least one of family members, friends, relatives, colleagues, doctors, lawyers, policemen, politicians, and the like.

In general, the UAVs are categorized into one of six functional categories. For example, 1) target and decoy providing ground and aerial gunnery a target that simulates an enemy aircraft or missile; 2) reconnaissance providing battlefield intelligence; 3) combat providing attack capability for high-risk missions, for instance Unmanned Combat Air Vehicle (UCAV); 4) logistics providing for cargo and logistics operations; 5) research and development providing for further development of UAV technologies to be integrated into field deployed UAV aircrafts; and 6) civil and commercial providing for civil and commercial applications.

Further, in general, the UAVs are categorized in terms of at least one of range and altitude. For instance, 1) hand-held with an altitude of approximately 2,000 ft (600 m) altitude and a range of approximately 2km; 2) close with an altitude of approximately 5,000 ft (1,500 m) and a range of approximately 10 km range; 3) NATO type with an altitude of approximately 10,000 ft (3,000 m) altitude and a range of approximately 50 km range; 4) tactical with an altitude of approximately 18,000 ft (5,500 m) altitude and a range of approximately 160 km range; 5) Medium Altitude, Long Endurance (MALE) with an altitude of approximately 30,000 ft (9,000 m) and a range of approximately 200 km; 6) High Altitude, Long Endurance (HALE) with an altitude of approximately 30,000 ft (9,100 m) and an indefinite range; 7) High-Speed, Supersonic (HYPERSONIC) (Mach 1-5) or HYPERSONIC (Mach 5+) with an altitude of approximately 50,000 ft (15,200 m) or suborbital altitude and a range of approximately 200 km; 8) ORBITAL low earth orbit (Mach 25+); 9) CIS Lunar Earth-Moon transfer; and 10) Computer Assisted Carrier Guidance System (CACGS) for UAVs.

In some embodiments, the UAV may be designed and implemented in accordance with the principles of the present invention. For example, and in no way limiting the scope of the invention, the UAV 400 is at least one of a miniature UAV, Small UAV (SUAV), Micro Air Vehicle (MAV), drone, Remotely Piloted Aircraft (RPA), Radio-Controlled (model) aircraft (RC aircraft or RC plane) and a quadcopter. Specifically, the UAV 400 is capable of flying autonomously without a human pilot aboard. More specifically, the autonomous flight of the UAV 400 is controlled at least one of fully autonomously via onboard computers, and partially manually via a remote control of, or with, the human pilot on at least one of the ground and in another vehicle. Still more specifically, the launch and recovery method of the UAV 400 is performed at least one of fully automatically via usage of the onboard computers, and partially manually via the human pilot equipped with the remote control confined to at least one of the ground and in another vehicle.

In some embodiments, the UAV is capable of autonomously and automatically taking off, landing, and flying via design and implementation of Artificial Intelligence (AI) based systems, wherein the UAV is merely instructed as per the desired mission.

In some embodiments, the UAV is a powered, aerial vehicle without a human operator on board. Specifically, the UAV 400 is capable of using aerodynamic forces to provide vehicle lift. More specifically, the UAV 400 is capable of at least one of flying automatically, autonomously, carrying non-lethal payloads and being remotely piloted, expended and recovered.

In some embodiments, deployment of one or more Unmanned Aerial Vehicles (UAVs) for managing public safety in at least one of unknown, unexpected, unwanted and untimely situations is disclosed, in accordance with the principles of the present invention. In some scenarios, the administrative body, i.e. the metropolitan corporation of a city, responsible for the civic and infrastructural assets of the metropolitan area of the city is subdivided into one or more zones for ease of administration. In use, one or more UAVs 400 is stationed at each of the head offices or headquarters corresponding to the zone therefor. Specifically, each zonal head office or headquarter comprises a zonal control subsystem. More specifically, the zonal control subsystem comprises one or more host computing units, i.e. servers. In some embodiments, a main control center comprises one or more zonal control subsystems.

In some scenarios involving deployment of UAVs 400 for managing public safety in at least one of unknown, unexpected, unwanted and untimely situations, at least one of a new and registered user, for instance at least one of a girl, woman, child and senior citizen, of a proprietary app, for instance the proprietary client-server SOAPSAAS application (app) 146 of FIG. 1, designed and implemented in accordance with the principles of the present invention, is at least one of prone (susceptible) and subjected (exposed) to one or more forms of sexual abuse, such as commercial sexual exploitation, pornography, prostitution, sex tourism, forced prostitution, genital modification and mutilation, rape, raptio, sexual assault, sexual bullying, sexual harassment, sexual misconduct, sexual slavery, sexual violence, obscene gestures, such as a-ok, anasyrma, bras d'honneur, cornuto, fig sign, finger, mooning, mountza, shocker and wanker.

In some scenarios in the event that at least one of a woman, child, teenager girl and veteran (elderly), i.e. a user, is exposed to one or more forms of sexual abuse in at least one of unknown, unexpected, unwanted and untimely situations, in use the user shouts and utters one or more pre-defined keywords, such as “HELP”. The proprietary client-server SOAPSAAS application (app) 146 facilitates identification of the pre-defined keywords uttered by the user as an indication of at least one of unknown, unexpected, unwanted and untimely situations. The proprietary client-server SOAPSAAS application (app) 146 facilitates sending a SOS with the location of the portable computing and communications device 104 running the proprietary client-server SOAPSAAS application (app) 146 plus at least one of captured audio, video and a combination thereof information to a server subsystem, for instance the cloud-based server subsystem 208 of FIG. 2. In some scenarios, the user dials one or more emergency telephone numbers, such as 000 (Australia), 108 (India), 111 (New Zealand), 112 (EU and various others), 117 (Philippines), 119 (parts of Asia and Jamaica), 911, (E-911) (North America) and 999 (UK and various others). In addition, the user dials one or more telephone numbers in the list of trusted group, for instance the one or more portable computing and communications devices 104 owned and operated by the at least one of PCR, mobile PCR vehicle and the at least one of family members, friends, relatives, colleagues, doctors, lawyers, policemen, politicians, and the like. The portable computing and communications (or wearable computing device) 104 facilitates at least one of sequentially, randomly and selectively capturing at least one of audio, visual, video and a combination thereof at each predetermined time interval. In some embodiments, the randomly captured at least one of audio, visual, video and a combination thereof at each predetermined time interval serves as evidence in connection with at least one of unknown, unexpected, unwanted and untimely situations.

The at least one of textual, verbal and multimedia SMS and SOS sent from the portable computing and communications device, for instance the wearable computing device 104, at least one of owned, operated and a combination thereof, by the at least one of woman, child, teenager girl and veteran (elderly) at least one of prone (or susceptible) to and subjected (or exposed) to one or more forms of sexual abuse comprises of the following: 1) the at least one of verbal and textual keywords, such as “HELP”; 2) the at least one of position and location coordinates, such as the latitude, longitude, altitude, and time of the incident; 3) the details of the user, such as the Personally Identifiable Information (PII); 4) optional historical profile of the user and the like. The at least one of textual, verbal and multimedia SMS and SOS is at least one of anycasted, broadcasted, multicasted, unicasted, geocasted and a combination thereof to at least one of the zonal headquarters in at least one of proximity and vicinity thereof. In use, the host computing units, i.e. servers, of a zonal control subsystem of a zonal headquarter therefor receive the at least one of textual, verbal and multimedia SMS and SOS. Upon reception of the at least one of textual, verbal and multimedia SMS and SOS, at least one UAV 400 stationed at the zonal headquarter is at least one of fully automatically, fully manually, partially manually, partially automatically and a combination thereof fed with the waypoint and a map therefor. Upon feed, the UAV 400 autonomously takes off from the source, i.e. the zonal headquarter, and fly towards the destination or waypoint based on the fed map.

In some embodiments, the flight control board of the UAV 400 facilitates the user to mark waypoints on a map, to which, or according to which, the UAV 400 flies and perform tasks, such as landing or gaining altitude. Specifically, the waypoints are marked on a map rendered on the display of a portable computing and communications device, such as a tablet or pc device, to create a flight plan.

Upon reaching the destination, the UAV 400 facilitates capturing at least one of visuals, videos, audios, audio-visuals and multimedia information of the incident and facilitates at least one of data feed and web feed via streaming to at least one of the portable computing and communications devices of the members of the trusted group of the user, at least one of zonal headquarters, PCR, hospitals, doctors and lawyers in the online social network of the user.

In some scenarios involving deployment of the UAVs by the vehicle mobile police patrolling party, the proprietary client-server SOAPSAAS application (app) 146, of FIG. 1, loaded on the portable computing and communications device 104 of a police officer or personnel is in synchronization with the proprietary client-server SOAPSAAS application (app) 146 loaded on the portable computing and communications device 104 as a payload on the UAV 400, of FIG. 4. Upon reception of the at least one of textual, verbal and multimedia SMS and SOS, at least one UAV 400 stationed at the zonal headquarter is at least one of fully automatically, fully manually, partially manually, partially automatically and a combination thereof fed with the waypoint and a map therefor. Upon feed, the UAV 400 autonomously takes off from the source, i.e. the zonal headquarter, and flies towards the destination or waypoint based on the fed map. Upon reaching the destination, the UAV 400 facilitates capturing at least one of visuals, videos, audios, audio-visuals and multimedia information of the incident and facilitates at least one of data feed and web feed via streaming to at least one of the portable computing and communications devices 104 of the members of the trusted group of the user, at least one of zonal headquarters, PCR, hospitals, doctors and lawyers in the online social network of the user.

In some embodiments, the user owns and operates a low-end (or low cost) portable computing and communications device 104. In use, the low-end portable computing and communications device 104 facilitates displaying or rendering a textual map to a target (or destination) location of an incident. In addition, along with the textual map a session identifier is displayed. Further, in use, the user accesses the server capable of capturing or recording the incident. Upon accessing the server, the user feeds the session identifier to access and retrieve the recording of the incident. The proprietary client-server SOAPSAAS application (app) 146 prompts the user to access, thereafter at least one of view and hear, the recording of the incident in at least one of real time and non-real time.

In some scenarios involving managing safety of passengers or travelers in vehicles for hire in at least one of unknown, unexpected, unwanted and untimely situations thereof, a passenger or traveler, for instance at least one of a girl, woman, child and senior citizen, uses the proprietary client-server SOAPSAAS application (app) 146 designed and implemented in accordance with the principles of the present invention.

In some embodiments, all cab operators are required to register the corresponding details thereof on a central database running or hosted on a centralized server subsystem. Specifically, the drivers of cabs operated by the cab operators are required to register the corresponding details on the central database running or hosted on the centralized server subsystem. For example, and in no way limiting the scope of the invention, the drivers are required to register at least one of the Mobile Identification Number (MIN) or Mobile Subscription Identification Number (MSIN), Subscriber Identity Module or Subscriber Identification Module (SIM), International Mobile Subscriber Identity (IMSI), and a combination thereof, in connection with each of one or more portable computing and communications devices 104 owned and operated by the drivers. Further, the at least one of the Mobile Identification Number (MIN) or Mobile Subscription Identification Number (MSIN), Subscriber Identity Module or Subscriber Identification Module (SIM), International Mobile Subscriber Identity (IMSI), and a combination thereof, of the GPS receiver and 3G communication module of the cab or automobile are also registered on the central database running or hosted on the centralized server subsystem. Still further, all cab operators are required to update any and all cab bookings made by customers or passengers into the central database running or hosted on the centralized server subsystem.

In use, a passenger books a cab. Upon successful completion of booking by the customer or passenger, the driver of the cab arrives at the source physical location specified by the customer. In some scenarios, the passenger, for instance at least one of a girl, woman, child and senior citizen, uses the proprietary client-server SOAPSAAS application (app) 146, of FIG. 1, designed and implemented in accordance with the principles of the present invention, and loaded or installed on the portable computing and communications device 104, of FIG. 1, owned and operated by the passenger. Specifically, the passenger accesses the proprietary client-server SOAPSAAS application (app) 146 via touching an icon therefor. More specifically, the passenger is prompted to synchronize the proprietary client-server SOAPSAAS application (app) 146 with the GPS receiver of the car or cab. During synchronization, the passenger is prompted to ensure whether or not the cab driver details are correct and whether or not the GPS receiver of the cab is in working condition. Thus, the GPS receiver of the portable computing and communications device, for instance at least one of a smart phone and wearable computing device, owned and operated by the passenger is in synchronization with the GPS receiver of the cab. Upon ensuring the correctness and proper working condition of the GPS receiver of the cab, the GPS receiver of the car or cab is locked till the completion of journey of the passenger from a given source physical location to a given destination physical location. In some scenarios, the GPS receiver of the car or cab is contained in at least one of tamper-proof, tamper-resistant and tamper-evident cabinet or housing and is an active GPS receiver. In some embodiments, the GPS receiver of the cab is coupled to at least one of Near Field Communication, Bluetooth®, Infrared (IR) modules and a combination thereof, thereby facilitating wireless transmission and reception of data.

Advantageously, in some scenarios, the corresponding IMEI numbers facilitate detection of last know position or location of passenger and driver, in the event that corresponding GPS receivers fails.

Still advantageously, in some scenarios, the proximity of the IMEI number of the portable computing and communications device 104 owned and operated by the driver vis-à-vis the IMEI number of the portable computing and communications device 104 owned and operated by the passenger facilitates determining whether or not the driver is with the passenger.

In some embodiments, the wearable computing devices, designed and implemented in accordance with the principles of the present invention, facilitate any and all types of connectivity by means, or virtue, of which persons owning the same at least one of get connected and remain connected to a remote server subsystem in at least one of unknown, unexpected, unwanted and untimely situations. For example, and by no way of limitation, the system for integrated public safety (or security) management facilitates implementation of one or more protocols, cellular network standards, services, namely Unstructured Supplementary Service Data (USSD), Short Message Service (SMS), Electronic Mail (EMAIL), 2G, 3G, Interactive Voice Response (IVR) Call Screening and Recording and helpline, thereby facilitating Anytime, Anywhere and Anyhow connectivity to the remote server subsystem to persons owning the wearable computing devices.

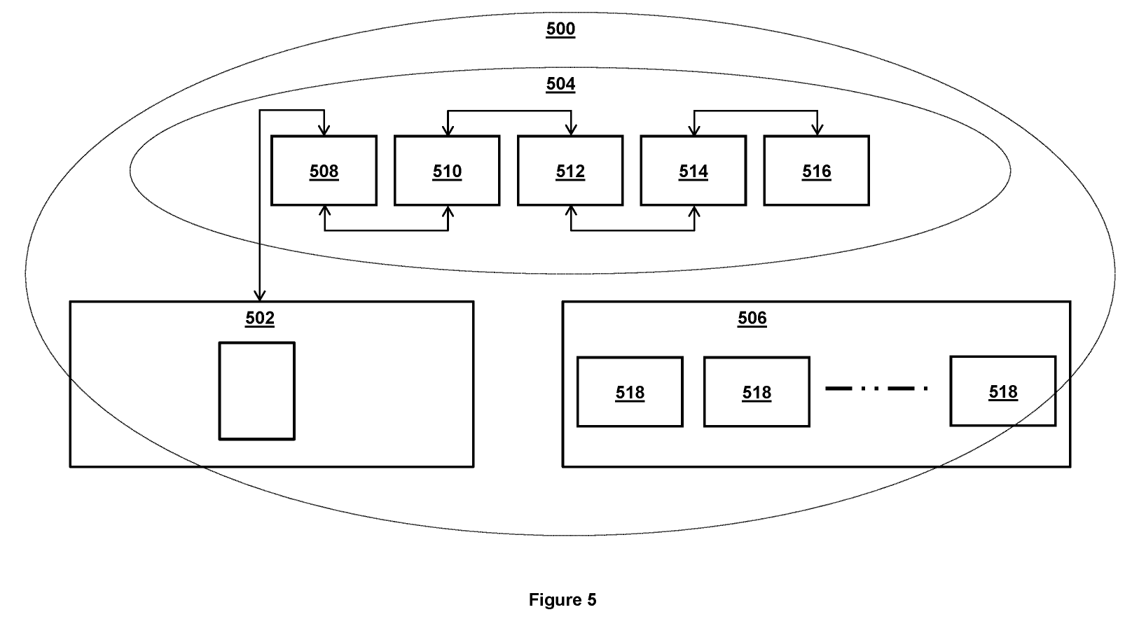

FIG. 5 depicts a potential use case scenario involving deployment and implementation of the system facilitating streamlined, seamless, continuous connectivity Anytime, Anywhere and Anyhow to a remote server subsystem to persons owning the wearable computing devices, according to one or more embodiments.

The system 500 comprises a client subsystem 502, network subsystem 504 and server subsystem 506. Specifically, the network subsystem 504 comprises a Base Transceiver Station (BTS) 508, Base Station Controller or Subsystem (BSC or BSS) 510, Mobile Switching Center (MSC) 512, Home Location Register (HLR) 514 and Gateway Mobile Switching Centre (GMSC) 516.

As depicted in FIG. 5, the server subsystem 506 comprises one or more host computing units 518 serving as servers.

The BTS 508 facilitates wireless communication between one or more wearable computing devices 502 and the network subsystem 504. For example, and in no way limiting the scope of the invention, the network subsystem 504 is based on any of the wireless communication technologies, such as Global System for Mobile Communications (GSM), Code Division Multiple Access (CDMA), Wireless Local Loop (WLL), Wi-Fi, WiMAX or other Wide Area Network (WAN) technology.

The BSS or BSC 510 facilitates handling traffic and signaling between the wearable computing device 502 and a Network Switching Subsystem (NSS) (not shown here explicitly). Specifically, the BSS 510 facilitates transcoding of speech channels, allocation of radio channels to mobile phones or wearable computing devices 502, paging, transmission and reception over the air interface and many other tasks related to a radio network.

The MSC 512 serves as the primary service delivery node for GSM/CDMA, thereby facilitating routing voice calls and SMS as well as other services, such as conference calls, FAX and circuit switched data. The MSC 512 facilitates setting up and releasing the end-to-end connection, handling mobility and handing over requirements during the call as well as taking care of charging and real time pre-paid account monitoring. In some scenarios involving use of the GSM mobile phone system, in contrast with earlier analogue services, fax and data information is sent directly digitally encoded to the MSC 512. Upon reaching the MSC 512, the directly digitally encoded fax and data information is re-coded into an “analogue” signal.

In some embodiments, the MSC is implemented as a Mobile Switching Center Server (MSCS). The MSCS is a soft-switch variant of the MSC, which provides circuit-switched calling mobility management, and GSM services to the wearable computing devices or mobile phones roaming within the area that are served by the MSCS. The functionality of the MSCS facilitates enabling splitting between control (signaling) and user plane (bearer in network element called as Media Gateway/MG), thereby guaranteeing better placement of network elements within the network subsystem.

The MSC 512 facilitates connection to the following elements, namely 1) the HLR 514 for obtaining data about the Subscriber Identity or Identification Module (SIM) and mobile services Integrated Services for Digital Network (ISDN) number (Mobile Station International Subscriber Directory Number MSISDN, i.e. the telephone number); 2) the BSS 510, which facilitates handling the radio communication with 2G and 2.5G mobile phones or the wearable computing devices 502; 3) the Universal Mobile Telecommunications System (UMTS) Terrestrial Radio Access Network (UTRAN), which facilitates handling the radio communication with 3G mobile phones or wearable computing devices 502; 4) a Visitor Location Register (VLR), not shown here explicitly, which facilitates providing subscriber information in the event that the subscriber is outside the home network therefor; and 5) other MSCs 512 for procedures, such as handover.

in addition, the MSC 512 facilitates implementation of one or more of the following functions: 1) delivering calls to subscribers, for instance the owners of the wearable computing devices 502, upon arrival of the calls based on information from the VLR; 2) connecting outgoing calls to other mobile subscribers, for instance the owners of the wearable computing devices 502, or the Public Switched Telephone Network (PSTN), not shown here explicitly; 3) delivering SMSs from subscribers to a Short Message Service Center (SMSC), not shown here explicitly, and vice versa; 4) arranging handovers from one BSC 510 to another; 5) carrying out handovers from the MSC 512 to another; 5) supporting supplementary services, such as conference calls or call hold; and 6) generating billing information.

The HLR 514 serves as a central database comprising details of each mobile phone subscriber or wearable computing device 502 that is authorized to use the GSM core network. In some scenarios, there are several logical, and physical, HLRs 514 per Public Land Mobile Network (PLMN), not shown here explicitly, though one International Mobile Subscriber Identity (IMSI)/MSISDN pair is associated with only one logical HLR 514, which spans several physical nodes, at a time.

One or more of the HLR 514 facilitates storing details of every SIM card issued by the mobile phone operator, not shown here explicitly. Each SIM has a unique identifier called an International Mobile Subscriber Identity (IMSI), which is the primary key to each HLR record.

Another important item of data associated with the SIM is the MSISDNs, which is the telephone numbers used by mobile phones to make and receive calls. The primary MSISDN is the number used for making and receiving voice calls and SMS, but it is possible for a SIM to have other secondary MSISDNs associated therewith for fax and data calls. Each MSISDN is also a primary key to the HLR record. The HLR data is stored for as long as a subscriber remains with the mobile phone operator.

In some exemplary embodiments, the other data stored in the HLR 514 against an International Mobile Subscriber Identity (IMSI) record is: 1) GSM services that the subscriber requested or been given; 2) GPRS settings to allow the subscriber to access packet services; 3) Current location of subscriber (VLR and serving GPRS support node/SGSN); 4) Call divert settings applicable for each associated MSISDN. The HLR 514 facilitates directly receiving and processing Mobile Application Part (MAP) transactions and messages from elements in the GSM network, for example, the location update messages received as mobile phones roam around.

In some embodiments, the HLR is coupled to one or more GSM core network elements, namely 1) the G-MSC for handling incoming calls, 2) the VLR for handling requests from mobile phones (or portable or wearable computing and communications devices) to attach to the network, 3) the SMSC for handling incoming SMSs, 4) the voice mail system for delivering notifications to the mobile phone (or portable or wearable computing and communications devices) that a message is waiting, and 5) the Authentication Center (AuC) for authentication and ciphering and exchange of data (triplets).

In operation, the main function of the HLR 514 is to manage the fact that SIMs and phones (or portable or wearable computing and communications devices) move around a lot. Thus, the HLR 514 implements the following procedures to manage the excessive movement of the phones (or portable or wearable computing and communications devices). Firstly, the HLR 514 manages the mobility of subscribers by means of updating the position of the subscribers in administrative areas called ‘location areas’, which are identified with a LAC. The action of a user of moving from one LA to another is followed by the HLR 514 with a Location area update procedure. Secondly, the HLR 514 sends the subscriber data to a VLR or SGSN, upon finding for the first time the subscriber roaming in there. Thirdly, the HLR 514 serves as a broker between the G-MSC or SMSC and the subscriber's current VLR in order to allow incoming calls or text messages to be delivered. Fourthly, the HLR 514 removes the subscriber data from the previous VLR, upon roaming or moving away of the subscriber from the previous VLR. Eventually, the HLR 514 is responsible for all SRI related queries (i.e. for invoke SRI, HLR should give sack SRI or SRI reply).

In some scenarios, the Network Switching Subsystem (NSS) (or GSM core network) 520 constitutes a GSM system (not shown here explicitly). The NSS 520 facilitates implementation of call switching and mobility management functions for mobile phones 502 roaming on the network of one or more BTS(s) 508. The NSS 520 is owned and deployed by mobile phone operators, thereby facilitating mobile devices 502 to communicate with each other and telephones in the wider Public Switched Telephone Network (PSTN) (not shown here explicitly). The architecture contains specific features and functions which are needed because the phones are not fixed in one location.

The mobile switching centre (MSC) is the primary service delivery node for GSM/CDMA, responsible for routing voice calls and SMS as well as other services (such as conference calls, FAX and circuit switched data).

The Gateway Mobile Switching Centre (GMSC) or Gateway MSC (G-MSC) 516 serves as the MSC thereby facilitating determining which visited MSC the subscriber who is being called, i.e. callee, is currently located at. The G-MSC 516 also interfaces with the PSTN. All mobile to mobile calls and PSTN to mobile calls are routed through a G-MSC. The term is only valid in the context of one call since any MSC provides both the gateway function and the Visited MSC function. However, some manufacturers design dedicated high capacity MSCs which do not have any BSSs connected thereto. The foregoing MSCs are the Gateway MSCs 516 for many of the calls handled thereby.

Reiterating again, as depicted in FIG. 5, the server subsystem 506 comprises one or more host computing units 518 serving as servers. In some embodiments, the server subsystem 506 comprises a Session Initiation Protocol (SIP) server 522 and Common Channel Signaling System 7 (CCS7) server 524.

The SIP server 522 is the main component of an IP (Internet Protocol) PBX (Private Branch Exchange) (not shown here explicitly). The IP PBX provides for audio, video, and instant messaging communications through the TCP/IP protocol stack for the internal network thereof and interconnecting the internal network with the PSTN for telephony communication. The SIP server 522 facilitates dealing with the setup of all SIP calls in the network 504. The SIP server 522 is also referred to as a SIP Proxy or a Registrar. Although the SIP server 522 is the most important part of the SIP based phone system, however the SIP server 522 only facilitates handling call setup and call tear down. The SIP server 522 does not facilitate actually transmitting or receiving any audio.

As depicted in FIG. 5, the client subsystem 502 comprises one or more portable and wearable computing and communications devices 502 each communicably coupled to one or more BTS(s) 508.

In some scenarios, the Mobile Network Operator (MNO), also known as a wireless service provider, wireless carrier, cellular company, or mobile network carrier, serves as a provider of wireless communications services. The MNO owns or controls all the elements necessary to sell and deliver services to an end user including radio spectrum allocation, wireless network infrastructure, back haul infrastructure, billing, customer care, provisioning computer systems and marketing and repair organizations. In some scenarios, the MNO allocates a short code for use by the system 100 or 500, of FIG. 1 or 5, for instance “124”. In some scenarios, the short code is hard coded into each of the one or more portable and wearable computing and communications devices 502.

As used in the current context, the term “hard coding” refers to the software development practice of embedding what may, perhaps only in retrospection, be considered an input or configuration data directly into the source code of a program or other executable object, or fixed formatting of the data, instead of obtaining that data from external sources or generating data or formatting in the program itself with the given input.

In some scenarios, upon utterance by a user of the keyword “HELP”, the one or more portable and wearable computing and communications devices 502 dial the short code “124”, thereby connecting to the one or more host computing units 518 serving as servers for the system 100 or 500 of FIG. 1 or 5.

In some use case scenarios, the system facilitates transmission and reception of data or information over one or more generations of mobile telecommunications technology, in accordance with the principles of the present invention. For example, and in no way limiting the scope of the invention, the one or more generations of mobile telecommunications technology comprises of A) the Second Generation (2G) mobile telecommunications technology, in turn, comprising 1) the GSM and Circuit Switched Data (CSD) protocols under the GSM/3GPP protocol family, 2) cdmaOne (TIA/EIA/IS-95 and ANSI-J-STD 008) protocols under the 3GPP2 protocol family, 3) D-AMPS (IS-54 and IS-136) protocols under the AMPS protocol family and 4) CDPD, iDEN, PDC and PHS protocols under other protocol families; B) the 2G transitional (2.5G, 2.75G) mobile telecommunications technology, in turn, comprising 1) HSCSD, GPRS and EDGE/EGPRS (UWC-136) protocols under the GSM/3GPP protocol family, 2) CDMA2000 1X (TIA/EIA/IS-2000) and 1X Advanced under the 3GPP2 family and 3) WiDEN under other protocol families; C) the 3G (IMT-2000) mobile telecommunications technology, in turn, comprising 1) UMTS (UTRA-FDD/W-CDMA, UTRA-TDD LCR/TD-SCDMA, UTRA-TDD HCR/TD-CDMA) protocols under the 3GPP protocol family and 2) CDMA2000 1xEV-DO Release 0 (TIA/IS-856) protocols under the 3GPP2 family; D) the 3G transitional (3.5G, 3.75G, 3.9G) mobile telecommunications technology, in turn, comprising 1) HSPA, HSDPA, HSUPA, HSPA+ and LTE (E-UTRA) protocols under the 3GPP protocol family and 2) CDMA2000 1xEV-DO Revision A (TIA/EIA/IS-856-A), EV-DO Revision B (TIA/EIA/IS-856-B) DO Advanced protocols under the 3GPP2 protocol family and 3) Mobile WiMAX, IEEE 802.16e Flash-OFDM and iBurst IEEE 802.20 protocols under the IEEE protocol family and E) 4G (IMT Advanced) mobile telecommunications technology, in turn, comprising 1) LTE Advanced (E-UTRA) protocol under the 3GPP protocol family and 2) WiMAX (IEEE 802.16m) protocol under the IEEE protocol family. In some use case scenarios, the system facilitates transmission and reception of data or information over 3G network. Specifically, the data or information is at least one of transmitted and uploaded to a cloud-based server. In some use case scenarios, one or more users wearing the wearable computing devices perform exercise in at least one of an indoor gymnasium and outdoor park. In use, in the presence of GPS signals, the wearable computing devices are fully automatically set into a predefined operation mode, namely the “GYM” mode, based on the detection of the locations of the wearable computing devices in at least one of proximity to and inside the indoor gymnasium. In the event that the GPS signals are absent, the wearable computing devices are manually set into the predefined operation mode, namely the “GYM” mode. Specifically, the wearable computing devices are fully manually set into the predefined operation mode, namely the “GYM” mode, via pressing buttons on the devices. In some scenarios, the wearable computing devices are partially manually set into the predefined operation mode, namely the “GYM” mode, via voice-based activation of the predefined operation mode, namely the “GYM” mode.

In some scenarios involving a wearable computing device in “POWER ON” mode, the wearable computing device immediately conducts a Power-On Self-Test (POST) using firmware or software routines. Upon completion of the POST, the wearable computing device is subjected to secure booting process based on the secure boot protocol, as per the Unified Extensible Firmware Interface (UEFI) specification. The secure booting process facilitates preventing the loading of drivers or OS loaders that are not signed with an acceptable digital signature. In some scenarios involving implementation of secure booting process, upon enablement, the secure booting process is initially placed in “setup” mode, which facilitates writing a public key known as the “Platform key” (PK) to the firmware. Upon completion of writing, the secure booting process enters a “User” mode, wherein only drivers and loaders signed with the platform key are loaded by the firmware. Additional “Key Exchange Keys” (KEK) are added to a database stored in memory to allow other certificates to be used, but the KEK must still have a connection to the private portion of the Platform key. Secure boot can also be placed in “Custom” mode, where additional public keys can be added to the system that does not match the private key.

In some embodiments, a method for the design and implementation of the integrated comprehensive public safety and emergency communication system using at least one of portable and wearable computing and communications devices and unmanned aerial vehicles is disclosed, in accordance with the principles of the present invention.

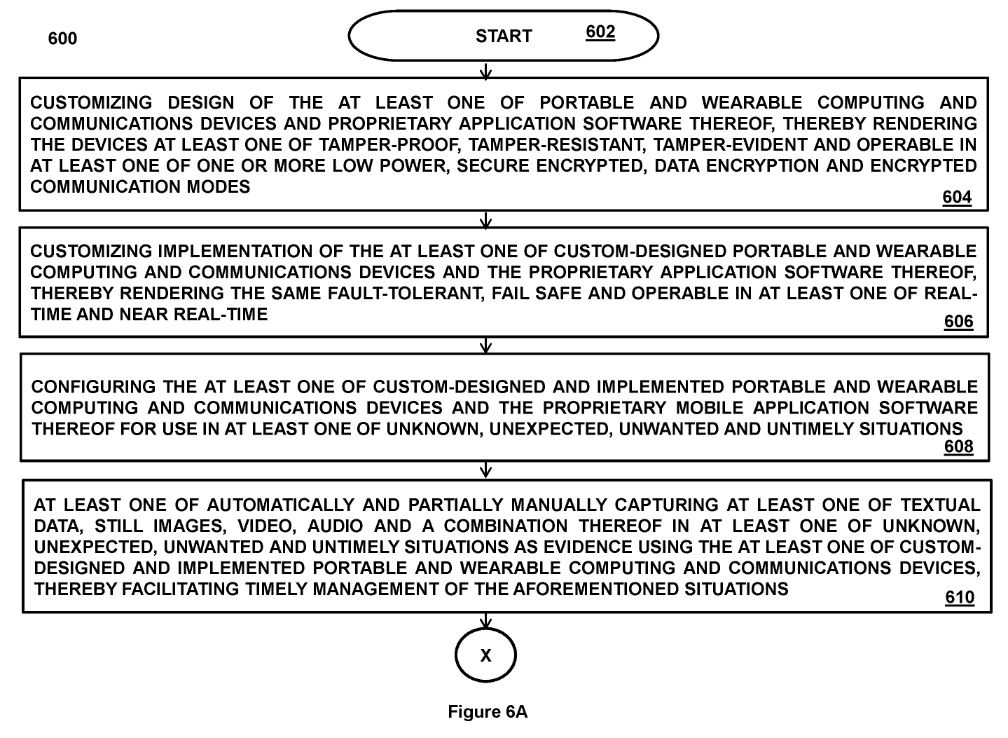

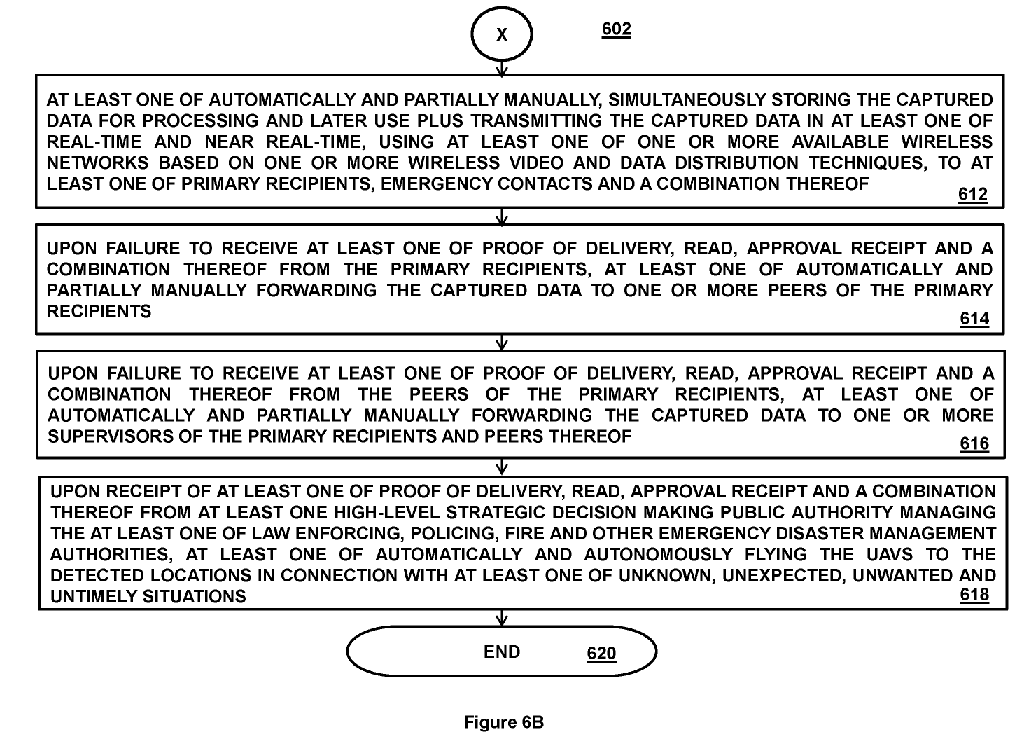

FIGS. 6A-B depict a flow diagram in connection to the method for the design and implementation of the integrated comprehensive public safety and emergency communication system, according to one or more embodiments.

The method 600 starts at step 602 and proceeds to step 604.

At step 604, the method 600 facilitates, or comprises, customizing the design of (or customizing) the at least one of portable and wearable computing and communications devices, for instance the at least one of portable and wearable computing and communications devices 104 of FIG. 1, comprising a proprietary mobile application software thereof, for instance the proprietary client-server SOAPSAAS application (app) 146 of FIG. 1, thereby rendering the same at least one of tamper-proof, tamper-resistant, tamper-evident and operable in at least one of one or more low power, secure encrypted, data encryption and encrypted communication modes. For instance, the custom-designed at least one of portable and wearable computing and communications devices are capable of operating in one or more low power modes, such as at least one of sleep, hibernation, hybrid sleep, Advanced Configuration and Power Interface (ACPI) and deep sleep modes.

In some embodiments, the at least one of portable and wearable computing and communications devices are designed to be implemented in, or automatically select from and implement, or selectively implement from, one or more user-defined explicit operation modes based on at least one of selective activation, deactivation and a combination thereof of one or more add-on components thereof. For instance, the one or more add-on components are at least one of an imaging device, a GPS sensor (receiver), GSM unit, one or more additional sensors, one or more auxiliary wireless communication units and one or more auxiliary positioning units. Specifically, the one or more user-defined explicit operation modes based on at least one of selective activation, deactivation and a combination thereof of one or more add-on components thereof are at least one of mapped onto and correspond to one or more potential real-time use case scenarios in connection with the at least one of unknown, unexpected, unwanted and untimely situations. For instance, the one or more real-time use case scenarios in connection with the at least one of unknown, unexpected, unwanted and untimely situations require at least one of a microphone, imaging device and a combination thereof based on the level of severity, and the kind of security required therefor.

In some embodiments, the at least one of portable and wearable computing and communications devices are designed to be implemented in, via at least one of autonomous automatic and partially manual selection of, at least one of predefined implicit and user-defined explicit operation modes correspondingly based on at least one of selective failover and selective switchover to one or more redundant or standby wireless networks upon at least one of failure, unavailability and timeout.

At step 606, the method 600 facilitates, or comprises, customizing the implementation of the at least one of custom-designed portable and wearable computing and communications devices and the proprietary mobile application software thereof, thereby rendering the same fault-tolerant, failsafe and operable in at least one of real-time and near real-time.

At step 608, the method 600 facilitates, or comprises, configuring the at least one of custom designed and implemented portable and wearable computing and communications devices and the proprietary mobile application software thereof for use in at least one of unknown, unexpected, unwanted and untimely situations.

At step 608, the method 600 further facilitates, or comprises, at least one of automatically and partially manually identifying and selecting one or more safe locations so as to populate a list of safe locations using the proprietary mobile application software on, or for use or consumption by, the at least one of custom designed and implemented portable and wearable computing and communications devices. Upon populating the list of safe locations, the method 600 further facilitates, or comprises, at least one of automatically and partially manually identifying and selecting one or more trusted group members so as to populate a list of trusted members using the proprietary mobile application software on, or for use or consumption by, the at least one of custom designed and implemented portable and wearable computing and communications devices. Upon populating the list of trusted members, the method 600 further facilitates, or comprises, at least one of automatically and partially manually identifying and selecting one or more safe time slots in given time periods, for instance at least one of those occurring intraday and interday, to safely traverse, or for safely traversing, the identified and selected list of safe locations.

At step 610, the method 600 facilitates, or comprises, at least one of automatically and partially manually capturing at least one of textual data, still images, video, audio and a combination thereof in at least one of unknown, unexpected, unwanted and untimely situations as evidence using the custom designed and implemented wearable computing and communications devices, thereby facilitating timely help. Specifically, in use, the automatic identification and selection of the list of safe locations is at least one of partly and entirely based on recommendations provided by the wearable computing and communications devices and the proprietary mobile application software thereof in connection with one or more locations previously traversed by the users or the peers thereof. Likewise, in use, the automatic identification and selection of the list of trusted members is at least one of partly and entirely based on recommendations provided by the wearable computing and communications devices and the proprietary mobile application software thereof in connection with one or more trusted members from whom the users received timely help in the past in, or during occurrence of, at least one of unknown, unexpected, unwanted and untimely situations.

At step 612, the method 600 facilitates, or comprises, at least one of automatically and partially manually, simultaneously storing the captured data for processing and later use plus transmitting the captured data in at least one of real-time and near real-time, using at least one of one or more available wireless networks based on one or more wireless video and data distribution techniques, to at least one of one or more primary recipients, such as law enforcing, policing, fire and other emergency disaster management authorities, friends and family members. For instance, the one or more primary recipients comprise at least one of first-level contacts (acquaintances) and emergency contacts.

At step 614, the method 600 facilitates, or comprises, upon failure to receive at least one of proof of delivery, read, approval receipt and a combination thereof from the primary recipients, at least one of automatically and partially manually forwarding the captured data to one or more peers of the primary recipients.

At step 616, the method 600 facilitates, or comprises, upon failure to receive at least one of proof of delivery, read, approval receipt and a combination thereof from the peers of the primary recipients, at least one of automatically and partially manually forwarding the captured data to one or more supervisors of the primary recipients and peers thereof.

At step 618, the method 600 facilitates, or comprises, upon receipt of at least one of proof of delivery, read, approval receipt and a combination thereof from at least one high-level strategic decision making public authority managing the at least one of law enforcing, policing, fire and other emergency disaster management authorities, at least one of automatically and autonomously flying the UAVs to the detected locations in connection with at least one of unknown, unexpected, unwanted and untimely situations.

The method 600 proceeds to step 620 and ends.

In some embodiments, the wearable computing device is in essence an Internet of Things (IOT)-enabled wearable computing and communications device. In some scenarios, the IOT-enabled wearable computing and communications device is capable of operating in one or more low power modes. For example, the IOT-enabled wearable computing device is capable of operating in at least one of sleep, hibernation, hybrid sleep and Advanced Configuration and Power Interface (ACPI) power modes. In some implementations involving energy efficient computing, the IOT-enabled wearable computing and communications device is capable of operating still in a relatively lower power state vis-à-vis the aforementioned low power modes referred to as a “deep sleep” power mode. The deep sleep mode is entered, for example, and in no way limiting the scope of the invention, by stopping a clock input signal to the processor, upon entering the sleep power mode of the processor, for instance the second microprocessor subunit 120 of FIG. 1. As a consequence, the deep sleep mode of the processor facilitates maintaining the operational state of the components of the IOT-enabled wearable computing and communication device, however the processor only draws power equivalent to the leakage current of the processor. In some scenarios, the IOT-enabled wearable computing and communications device further comprises an acoustic-to-electric transducer or sensor, for example a microphone, and a camera. In some scenarios involving implementation of the deep sleep mode, only the processor and microphone remain always on, thereby facilitating minimal consumption of power.

In use, a user at least one of manually and partially manually activates the IOT-enabled wearable computing and communications device via at least one of a button press and voice command. Upon activation, the user utters one or more predefined voice keywords, for example, and in no way limiting the scope of the invention, “HELP”. Further, the GPS module, for instance the second positioning subunit 140 based on Global Positioning System (GPS), of the IOT-enabled wearable computing and communications device, for instance at least one of the portable and wearable computing and communications device 104, of FIG. 1, pings periodically thereby synchronizing with the Base Transceiver Station (BTS). The BTS facilitates wireless communication between the IOT-enabled wearable computing and communications device and a network. For example, the network is based on one or more of the wireless communication technologies, such as Global System for Mobile Communications (GSM), Code Division Multiple Access (CDMA), Wireless Local Loop (WLL), Wi-Fi, Worldwide Interoperability for Microwave Access (WiMAX) or other Wide Area Network (WAN) technology.

Upon activation, the IOT-enabled wearable computing and communications device exits the deep sleep mode. Upon exiting the deep sleep mode, the IOT-enabled wearable computing and communications device is subjected to runtime verification or runtime integrity check. The runtime verification facilitates extracting information from the IOT-enabled wearable computing and communications device, and using the extracted information to detect and possibly react to observed behaviors satisfying or violating certain properties. In some scenarios, in the event that the IOT-enabled wearable computing and communications device successfully passes the runtime integrity check the following one or more steps are performed in a sequential manner. Firstly, the GPS module of the IOT-enabled wearable computing and communication device is activated. Upon activation of the GPS module, the GPS module captures the location data in connection with the IOT-enabled wearable computing and communications device. Secondly, the camera of the IOT-enabled wearable computing and communications device is activated. Upon activation of the camera, the camera starts capturing at least one of audio, video data and a combination thereof in connection with the captured location. Thirdly, the GSM module of the IOT-enabled wearable computing and communications device is activated. In some scenarios, the GSM module of the IOT-enabled wearable computing and communications device connects to the BTS. In some scenarios upon connection establishment, the HLR automatically detects the cloud server. Further, the GPS coordinates of the IOT-enabled wearable computing and communications device are sent over the USSD protocol. In response, the IOT platform backend server residing in, or confined to, the premises of the telecom service provider communicably coupled to the HLR receives the GPS coordinates of the IOT-enabled wearable computing and communications device. The HLR communicates with the GPS server in connection with real-time location of a callee IOT-enabled wearable computing and communications device, i.e. the IOT-enabled wearable computing and communications device in possession of, or owned and operated by, a member of the trusted group, and transmit the same. In some embodiments, the client subsystem comprises one or more other IOT-enabled portable computing and communications devices in various modalities. For example, and in no way limiting the scope of the invention, in some scenarios, the IOT-enabled portable computing and communications are at least one of a machine, UAV in at least one of proximity and vicinity of the callee or destination IOT-enabled and an IOT-enabled wearable computing and communications device of a member belonging to the trusted group of the caller or sender.

In some scenarios involving activation of the General Packet Radio Service (GPRS) service, the user is capable of transmitting at least one of audio, video and a combination thereof to the IOT platform backend server. Specifically, the GPRS service is implemented on the 2G and 3G cellular communication system's Global System for Mobile Communications (GSM).

In some embodiments involving deployment and implementation of at least one of the IOT-enabled wearable and portable computing and communications devices in at least one of Wireless Sensor Networks (WSNs) and Mobile WSNs, the at least one of the IOT-enabled wearable and portable computing and communications devices are capable of receiving data or information from one or more sensors at frequent intervals. Upon reception of data or information from one or more sensors at frequent intervals, the at least one of the IOT-enabled wearable and portable computing and communications devices wake up from the deep sleep mode in the event that the IOT-enabled wearable and portable computing and communications devices are on battery. For example, and in no way limiting the scope of the invention, at least one of the IOT-enabled wearable and portable computing and communications devices are deployed and implemented in at least one of Wireless Sensor Networks (WSNs) and Mobile WSNs in one or more areas of application, namely medical, industrial, energy, water, smart city and the like. In some scenarios in the event that the IOT-enabled wearable and portable computing and communications devices are coupled to power sources, the IOT-enabled wearable and portable computing and communications devices are always in wake-up mode, and thus connected to the network.

In some embodiments, methods for design and implementation of embedded device management systems for use in at least one of portable and wearable computing and communications devices are disclosed, in accordance with the principles of the present invention.

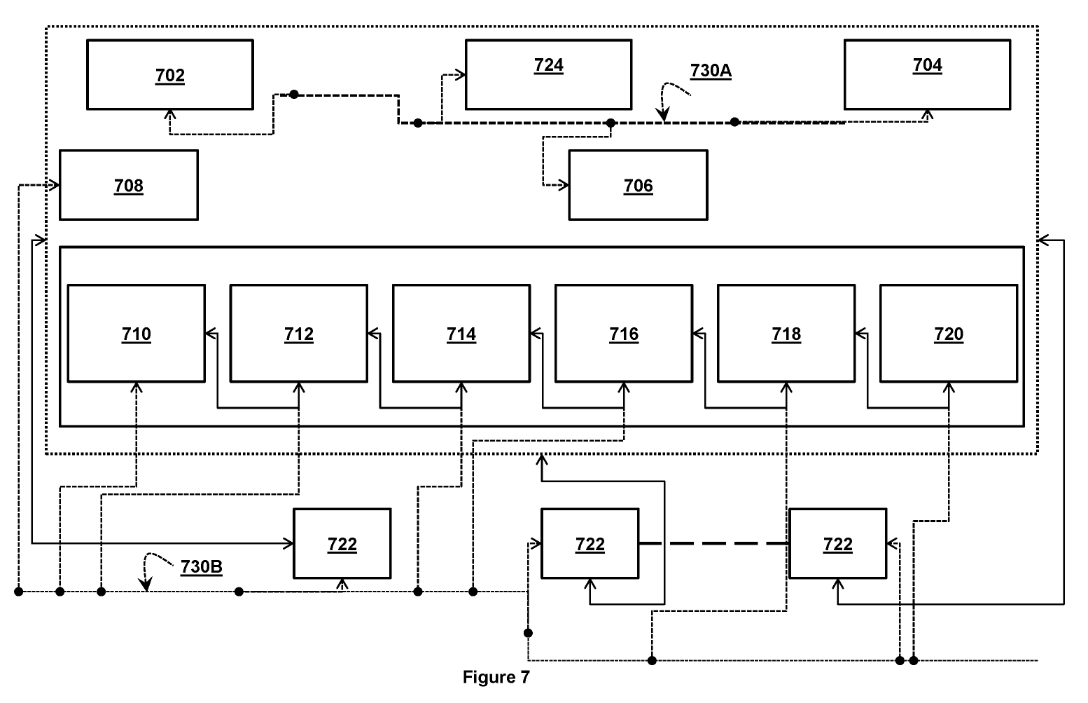

FIG. 7 depicts a block diagram of an embedded device management system for use in the at least one of portable and wearable computing and communications devices, according to one or more embodiments.

The embedded device management system 700 comprises at least one of a soft processor (or microprocessor) unit 702, for instance a Field-Programmable Gate Array (FPGA)-Based Central (or Micro) Processing Unit (FPGA-CPU or FPGA-MPU), and a hard processor (or microprocessor) unit 704, for instance CPU/MPU, a Programmable Power Management Unit (PPMU) 706, a Global Positioning System (GPS) sensor or receiver unit 708, at least one of a Third Generation (3G) communication unit 710, for instance a 3G wireless communication transceiver, a Fourth Generation (4G) communication unit 712, for instance a 4G wireless communication transceiver, a Fifth Generation (5G) communication unit 714, for instance a 5G wireless communication transceiver, a BLUETOOTH® unit 716, for instance a BLUETOOTH® wireless communication transceiver, a Near Field Communication (NFC) unit 718, for instance an NFC wireless communication transceiver, a Radio Frequency (RF) unit 720, for instance a RF wireless communication transceiver, and any and all potential combination(s) thereof, respectively.

With reference to FIGS. 1 and 7, the embedded device management system 700 is coupled to at least one of portable and wearable computing and communications devices 722 (or 104, of FIG. 1). In some scenarios, for example, and in no way limiting the scope of the invention, the portable and wearable computing and communications devices 722 (or 104, of FIG. 1) are proprietary customized portable and wearable computing and communications devices for public safety and emergency communication, custom-designed and implemented in accordance with the principles of the present invention. In some scenarios involving deployment of the proprietary customized portable and wearable computing and communications devices, the proprietary customized portable and wearable computing and communications devices 722 (or 104, of FIG. 1) are at least one of integrally, detachably and removably coupled to the embedded device management system 700. In some scenarios involving deployment of the conventional portable and wearable computing and communications devices, the conventional portable and wearable computing and communications devices 722 (or 104, of FIG. 1) are retrofitted with the embedded device management system 700.

In use, the embedded device management system 700 facilitates cold start of the at least one of portable and wearable computing and communications devices 722 (or 104, of FIG. 1). Specifically, the embedded device management system 700 facilitates start-up or booting, i.e. hard boot, of the at least one of portable and wearable computing and communications devices 722 (or 104, of FIG. 1) from power off state.

In some scenarios involving cold start of the at least one of portable and wearable computing and communications devices, the portable and wearable computing and communications devices 104, of FIG. 1, perform a Power-On Self-Test (POST).

In use, the PPMU 706 of the embedded device management system 700 facilitates cold start of the at least one of portable and wearable computing and communications devices 722 (or 104, of FIG. 1). In some scenarios, the means performing a deliberate reboot varies and includes at least one of 1) a manual, hardware-based means, wherein a power switch or reset button causes the at least one of portable and wearable computing and communications devices 722 (or 104, of FIG. 1) to reboot; 2) manual, software-based means, wherein software and Operating System (OS) triggers a reboot; and 3) automated means, wherein software is scheduled to run at a certain time and date, thereby facilitating scheduling a reboot.

Further, in use, a user is required to press a power button of the at least one of portable and wearable computing and communications devices 722 (or 104, of FIG. 1). Upon pressing the power button, the at least one of portable and wearable computing and communications devices 722 (or 104, of FIG. 1) automatically transfers control to the PPMU 706, by virtue of the customized design of the at least one of portable and wearable computing and communications devices 722 (or 104, of FIG. 1). Upon transference of control to the PPMU 706, the PPMU 706 generates a request for authentication of the at least one of portable and wearable computing and communications devices 722 (or 104, of FIG. 1). For example, and in no way limiting the scope of the invention, the authentication of the at least one of portable and wearable computing and communications devices 722 (or 104, of FIG. 1) is performed at least one of locally and remotely. In some scenarios involving local authentication, the at least one of soft processor (or microprocessor) unit 702 and hard processor (or microprocessor) unit 704, a Trusted Platform Module (TPM) 724 and the PPMU 706 are connected or coupled over a dedicated bus 730A for local authentication. In some scenarios, in use, in the event that the local authentication of the at least one of portable and wearable computing and communications devices 722 (or 104, of FIG. 1) is successful, the GPS sensor or receiver unit 708, at least one of the 3G communication unit 710, 4G communication unit 712, 5G communication unit 714, BLUETOOTH® communication unit 716, NFC communication unit 718, Radio Frequency (RF) communication unit 720, the at least one of soft processor (or microprocessor) unit 702, and hard processor (or microprocessor) unit 704, a microphone 726 and a camera 728 (not shown here explicitly) are all coupled to a dedicated bus 730B independent from a normal or standard bus 732 (not shown here explicitly). In some scenarios, all components of the at least one of portable and wearable computing and communications devices 722 (or 104, of FIG. 1), including, but not limited to, OS and application software are powered ON (or active) all the time. In some scenarios involving remote authentication, a cloud-based authentication server 734 (not shown here explicitly) connects with the at least one of portable and wearable computing and communications devices 722 (or 104, of FIG. 1). In some alternative scenarios, a remote authentication server 734 attempts to connects, or establish connection, with the at least one of portable and wearable computing and communications devices 722 (or 104, of FIG. 1) deployed in the field. In operation, the remote authentication server 734, for instance a cloud-based server, attempts to connect, or establish connection, with the at least one of portable and wearable computing and communications devices 722 (or 104, of FIG. 1) deployed in the field using at least one of a wired and wireless communication channel. Further, the request for authentication generated from the remote authentication server 734 is received by the PPMU 706. Upon reception of the request for authentication generated from the remote authentication server 734, the at least one of soft processor (or microprocessor) unit 702 and hard processor (or microprocessor) unit 704, a Trusted Platform Module (TPM) 724 and the PPMU 706 are connected or coupled over the dedicated bus 730A for remote authentication. Further, in operation, the dedicated bus 730A for remote authentication handovers or hands-off data connection to the normal or standard bus 732.

In some embodiments, the TPM 724 is built-in in the at least one of portable and wearable computing and communications devices 722 (or 104, of FIG. 1). Specifically, in some scenarios, the TPM 724 is co-located with, or in, the PCB of the at least one of portable and wearable computing and communications devices 722 (or 104, of FIG. 1).

In some embodiments involving successful authentication, the PPMU 706 supplies power to the at least one of soft processor (or microprocessor) unit 702 and hard processor (or microprocessor) unit 704, TPM 724, camera 728, GPS sensor or receiver unit 708 and an additional GPRS unit 736 (not shown here explicitly), respectively. Besides, the PPMU 706 supplies power to any and all additional units coupled to the at least one of portable and wearable computing and communications devices 722 (or 104, of FIG. 1). In use, a user is required to boot the at least one of portable and wearable computing and communications devices 722. Upon booting, the at least one of portable and wearable computing and communications devices 722 (or 104, of FIG. 1) performs a Power-On Self-Test (POST). Upon completion of the POST, the at least one of portable and wearable computing and communications devices 722 (or 104, of FIG. 1) reports the results of the POST to the PPMU 706.

In some scenarios, in the event that the POST fails, the relevant error is reported on the display of the at least one of portable and wearable computing and communications devices 722 (or 104, of FIG. 1). In some scenarios involving failure of the POST, the user is required to verify whether or not the at least one of the 3G communication unit 710, 4G communication unit 712, 5G communication unit 714, BLUETOOTH® communication unit 716, NFC communication unit 718, Radio Frequency (RF) communication unit 720 is in connected state or online. In some scenarios involving failure of the POST despite the fact that the at least one of the 3G communication unit 710, 4G communication unit 712, 5G communication unit 714, BLUETOOTH® communication unit 716, NFC communication unit 718, Radio Frequency (RF) communication unit 720 is in online or connected state, the error report is transmitted to at least one of the cloud-based authentication server 734 and remote authentication server 734. In some scenarios involving failure of the POST in the event that the at least one of the 3G communication unit 710, 4G communication unit 712, 5G communication unit 714, BLUETOOTH® communication unit 1716, NFC communication unit 718, Radio Frequency (RF) communication unit 720 is in offline or disconnected state, the error report is displayed on the display of the at least one of portable and wearable computing and communications devices 722.

In some embodiments, one or more distinct modes of operation of the proprietary, custom-designed at least one of portable and wearable computing and communications devices based on the State of Charge (SOC) of the battery therein are disclosed, in accordance with the principles of the present invention. Specifically, the one or more distinct modes of operation of the proprietary, custom-designed at least one of portable and wearable computing and communications devices are explicit user-defined distinct modes of operation based on the State of Charge (SOC) of the battery therein. In some scenarios involving the SOC of the battery ranging from a minimum of approximately 50% to a maximum of approximately 100%, the PPMU 706 selectively supplies power to the at least one of soft processor (or microprocessor) unit 702 and hard processor (or microprocessor) unit 704, GPS sensor or receiver unit 708, at least one of the 3G communication unit 110, 4G communication unit 712, 5G communication unit 714, BLUETOOTH® communication unit 716, NFC communication unit 718, Radio Frequency (RF) communication unit 720 and the additional GPRS unit 736, respectively. In use, in turn the at least one of soft processor (or microprocessor) unit 702 and hard processor (or microprocessor) unit 704 selectively supplies power only to one or more necessary or mandatory components of the custom-designed at least one of portable and wearable computing and communications devices 722. In some scenarios, for example, and in no way limiting the scope of the invention, the at least one of soft processor (or microprocessor) unit 702 and hard processor (or microprocessor) unit 704 selectively supplies power only to the native Static Random-Access Memory (static RAM or SRAM) 738 (not shown here explicitly) thereof. As a consequence, the other components of the at least one of soft processor (or microprocessor) unit 702 and hard processor (or microprocessor) unit 704 remain in at least one hibernation and power-off mode. In some scenarios, for example, and in no way limiting the scope of the invention, the PPMU 706 selectively supplies power to the GPS sensor or receiver unit 708. In some potential real-time use case scenarios, the GPS sensor or receiver unit 708 wakes up periodically, thereby facilitating detecting and capturing the coordinates of the at least one of portable and wearable computing and communications devices 722. Upon detection and capture of the coordinates, the GPS sensor or receiver unit 708 all over again goes into hibernation mode. In some scenarios involving at least one of availability and unavailability of GPS satellite signals, the at least one of portable and wearable computing and communications devices 722 accesses a pre-defined server 740, thereby facilitating retrieving and downloading pre-defined satellite data to, in turn, facilitate acquisition of assisted coordinates using Assisted GPS (AGPS).

In some embodiments, one or more potential real-time use case scenarios in connection with at least one of location-based, location-aware, context-sensitive, context-aware, context-dependent, and combinations thereof, acquisition of GPS coordinates using the at least one of portable and wearable computing and communications devices is disclosed, in accordance with the principles of the present invention. Specifically, one or more quantitative figures of merit in connection with the Time To First Fix (TTFF) referred to as the measure of the time required for a GPS receiver to acquire satellite signals and navigation data, and calculate a position solution (called a fix) in the one or more potential real-time use case scenarios are disclosed, in accordance with the principles of the present invention. In some potential real-time use case scenarios involving Open to the Sky architecture, for example, and in no way limiting the scope of the invention, in the event that only the GPS receiver of the present system is used to acquire satellite signals and navigation data, and calculate a position solution (called a fix), the TTFF is approximately 25 seconds. In some alternative potential real-time use case scenarios involving Open to the Sky architecture in connection with Open Sky Internet via Satellite, for example, and in no way limiting the scope of the invention, in the event that AGPS is implemented, the AGPS data downloaded every day morning is used to calculate coordinates, thereby leading to a time delay of approximately 5 seconds, in turn, facilitating saving battery power. In some potential real-time use case scenarios involving signal attenuation caused by construction materials in basements of buildings and multiple reflections at surfaces caused by multi-path propagation thereby leading to uncontrollable errors, the satellite based GPS loses significant power indoors. In use, no GPS signals, however GPRS are available for providing AGPS data from the server on Internet, thereby facilitating acquisition of coordinates. In some alternative scenarios, no GPS signals, however at least one of Unstructured Supplementary Service Data (USSD) channel and Short Message Service (SMS) are available for providing AGPS data from the server on Internet, thereby facilitating acquisition of coordinates.

In some scenarios involving fail safe mode of operation, the GPS unit is powered on continually and utilizes a mix of GPS and AGPS, thereby facilitating acquisition of coordinates.

Reiterating again, in some scenarios involving the SOC of the battery ranging from a minimum of approximately 50% to a maximum of approximately 100%, the PPMU 706 selectively supplies power to the at least one of the 3G communication unit 710, 4G communication unit 712, 5G communication unit 714, and additional GPRS unit 736. In some scenarios involving normal mode of operation, the at least one of portable and wearable computing and communications devices 722 is completely powered off. In some scenarios involving hibernation mode of operation, the at least one of portable and wearable computing and communications devices 722 wakes up and captures or acquires AGPS data, thereby facilitating providing the AGPS data to the GPS receiver or sensor, at least one of as and when (dynamically), as per need (adaptively) and a combination thereof to the GPS receiver or sensor prior to wakeup. In some scenarios involving fail safe mode of operation, the at least one of portable and wearable computing and communications devices 722 remain or stay connected with the cloud-based server continually.

Reiterating again, in some scenarios involving the SOC of the battery ranging from a minimum of approximately 50% to a maximum of approximately 100%, the PPMU 706 selectively supplies power to the drivers of one or more auxiliary or add-on devices of the at least one of portable and wearable computing and communications devices 722. For example, and in no way limiting the scope of the invention, the drivers are the GPS driver, microphone driver, battery module driver and GPRS/GSM driver.

In some scenarios involving the SOC of the battery ranging from a minimum of approximately 50% to a maximum of approximately 100%, the PPMU 706 selectively supplies power to at least one of an OS and application running on kernel.

In some scenarios involving the SOC of the battery ranging from a minimum of approximately 50% to a maximum of approximately 100%, the PPMU 706 cuts power supply to all the other units until the PPMU 706 receives an interrupt from at least one of the microphone 726, a button press event, a touch on the display of the at least one of portable and wearable computing and communications devices 722, the camera 728 and one or more physiological sensors, such as for body temperature, heartbeat, pulse, and the like.

In some scenarios involving interrupts from hardware or software indicating events that need immediate attention, the PPMU 706 facilitates selectively waking up at least one of add-on devices, peripherals and a combination thereof coupled to the at least one of portable and wearable computing and communications devices 722. For instance, in the event that the PPMU 706 receives interrupts from at least one of the microphone 126, a button press event, a touch on the display of the at least one of portable and wearable computing and communications devices 722, the camera 728 and one or more physiological sensors, such as for body temperature, heartbeat, pulse, and the like, the PPMU 706 facilitates waking up the camera 728, thereby facilitating recording. Likewise, the BLUETOOTH® communication unit 716, Three Axis Gyroscope and Wi-Fi are selectively wakened up by the PPMU 706 as and when required.

In some scenarios involving the SOC of the battery ranging from a minimum of approximately 0% to a maximum of approximately 30% in the normal mode of operation, the PPMU 706 of the at least one of portable and wearable computing and communications devices 722 facilitates selectively providing power to the at least one of FPGA-CPU or FPGA-MPU 702, and CPU/MPU 704, GPS sensor or receiver unit 708, one or more drivers the PPMU 706 selectively supply power to the drivers of one or more auxiliary or add-on devices of the at least one of portable and wearable computing and communications devices 722, at least one of an Operating System (OS) and application running on kernel, at least one of 3G communication unit 710, 4G communication unit 712, 5G communication unit 714 and additional GPRS unit 736. For example, and in no way limiting the scope of the invention, the drivers may be the GPS driver, microphone driver, battery module driver and GPRS/GSM driver.

In some scenarios involving the SOC of the battery ranging from a minimum of approximately 0% to a maximum of approximately 30% in the normal mode of operation, in the event that users of the at least one of portable and wearable computing and communications devices 722 cross (or traverse) a pre-defined geo-fence defining the virtual perimeter for a real-world geographic area, i.e. a given safe zone, in a given user configurable time period, the at least one of 3G communication unit 710, 4G communication unit 712, 5G communication unit 714 and additional GPRS unit 736 wakes up from hibernate mode. Specifically, in operation, the at least one of 3G communication unit 710, 4G communication unit 712, 5G communication unit 714 and additional GPRS unit 736 wakes up and collects Assisted GPS (AGPS) data. Upon awakening of the GPS sensor or receiver unit 708, the collected AGPS data is made available to the GPS sensor or receiver unit 708.

In some scenarios involving the SOC of the battery ranging from a minimum of approximately 0% to a maximum of approximately 30% in the normal mode of operation, in the event that an alert is triggered, the at least one of 3G communication unit 110, 4G communication unit 112, 5G communication unit 114 and additional GPRS unit 136 wakes up from hibernate mode. Specifically, in operation, the at least one of 3G communication unit 110, 4G communication unit 112, 5G communication unit 114 and additional GPRS unit 136 wakes up and collects Assisted GPS (AGPS) data. Upon awakening of the GPS sensor or receiver unit 108, the collected AGPS data is made available to the GPS sensor or receiver unit 108.

In some embodiments, self-(or autonomous) trainability and learnability of the PPMU based on chronological (or historical) usage and behaviour (or performance) thereof in one or more real-time use-case scenarios facilitating defining contexts, in turn facilitating adaptive and dynamic power management for the at least one of portable and wearable computing and communications devices is disclosed, in accordance with the principles of the present invention. In operation, the PPMU is capable of performing adaptive and dynamic SOC management for the battery.

In some embodiments, design and implementation of contingency or emergency traffic management system for managing situations of emergency and method therefor is disclosed, in accordance with the principles of the present invention. In some scenarios involving on-site, at least one of on the spot, in time, and Just-In-Time (JIT) emergency response to situations of emergency in excessive traffic congestion or jam on road, the emergency response vehicle receives the most optimal route map to reach the target destination, for instance the site of emergency, from the cloud server. In some worst case scenarios the emergency response vehicle gets stuck in the suggested or recommended most optimal route, and thus fails to reach the target destination in time. In use, the emergency response vehicle attempts to establish wireless connection with one or more traffic light signal posts in at least one of proximity and vicinity of the emergency response vehicle autonomously. In some scenarios the emergency response vehicle attempts to establish wireless connection with one or more traffic light signal posts in at least one of proximity and vicinity of the emergency response vehicle indirectly via a centralized traffic control room. In operation, the emergency response vehicle transmits an SOS message to the centralized traffic control room. Upon receipt of the SOS message, the centralized traffic control room retrieves the contents of the SOS message, for instance unique identifier of the emergency response vehicle, current GPS coordinates and unique identifier of one or more targeted traffic light signal posts. Further, in response, the centralized traffic control room attempts to alter the current states of the traffic lights on the targeted traffic light signal posts to desired or requested states by the emergency response vehicle or as-and-when, and as-per-need of the hour.

In some scenarios the emergency response vehicle attempts to establish wireless connection with one or more traffic light signal posts in at least one of proximity and vicinity of the emergency response vehicle directly (autonomously). In operation, in the event that the emergency response vehicle is standing in a queue behind one or more vehicles ahead thereof, the emergency response vehicle attempts to establish direct connection with the one or more traffic light signal posts in proximity via sending an SOS message thereto, which SOS message comprises the unique identifier of the emergency response vehicle, current GPS coordinates and unique identifier of one or more targeted traffic light signal posts. In some scenarios in the event that the emergency response vehicle is standing in a queue behind one or more vehicles ahead thereof, the emergency response vehicle attempts to establish indirect connection with the one or more traffic light signal posts in vicinity via sending an SOS message thereto via hoping from one vehicle to another in sequence and ahead thereof.

In some embodiments method and system for managing public safety in at least one of unknown, unexpected, unwanted and untimely situations via offering indemnity in conjunction with wearable computing and communications devices are disclosed, in accordance with the principles of the present invention. In use, the method and system of the present invention facilitate capturing the travel (or tour or travelling) profile of users comprising at least one of travel behavior, travel history, travel pattern and combinations thereof, for instance the travel profile of users, and family, friends, colleagues, contacts thereof, comprises one or more attributes, such as number or frequency of tours, trips or journeys in a given period of time, number of unique destination locations travelled in the given period of time from given unique source locations, number of times or frequency of travel to those unique destination locations in the given period of time from the given unique source locations, current locations of the users in current tours, at least one of unknown, unexpected, unwanted and untimely situations the users were at least one of susceptible, prone, exposed to, faced and met across in the tours in the past in the given period of time from given source locations to given destination locations, and the like. More specifically, the wearable computing and communications devices worn by the users facilitate capturing the overall profile of the users comprising the travel profile, which captured overall profile is transmitted and stored or uploaded on to the backend sever of the network for later use. Still, more specifically, the wearable computing and communications devices worn by the users facilitate capturing of at least one of a past and current overall context of travel of the users, and family, friends, colleagues, contacts thereof, analyzing the captured at least one of the past and current overall context of travel of the users, and family, friends, colleagues, contacts thereof, profiling the users, and family, friends, colleagues, contacts thereof based on the analyses, categorizing the users, and family, friends, colleagues, contacts thereof based on the profiling, recommending safety and security measures as well as one or more insurance products, plans or solutions, for instance insurance cover over basic amenities of life, such as food, clothing and shelter, and property, such as real, physical and intellectual. For example, and in no way limiting the scope of invention, the types of insurance offered are at least one of 1) health, for instance accidental death as well as dismemberment, dental disability (total permanent disability), income protection, long-term care, national health payment protection; 2) life, for instance mortgage life, permanent life, term life, universal life, variable universal life, whole life; 3) business, for instance bond, business owner, directors as well as officers liability, fidelity professional liability, protection as well as indemnity, trade credit and umbrella; 4) residential, for instance contents, earthquake, flood, home, landlords', lenders mortgage, mortgage, property, renters', title; 5) transport/communication, for instance aviation, computer, public auto, marine, satellite, shipping, travel, vehicle; and 6) others, for instance reinsurance, casualty, crime, crop, divorce, group, liability, no-fault, pet, terrorism, wage, war risk, weather workers', compensation, takaful.

In some scenarios involving managing public safety in at least one of unknown, unexpected, unwanted and untimely situations in home or residential locations, the users are offered indemnity in conjunction with smart static (or partially portable) computing and communications devices capable of functioning as a public safety network-based emergency communication system.

In some advantageous embodiments, the at least one of smart fixed, portable and wearable computing and communications devices designed and implemented in accordance with the principles of the present invention facilitate capturing context of use (or exposure) of the at least one of smart fixed, portable and wearable computing and communications devices and one or more user attributes, such as device usage chronological behaviour, pattern, age, sex or gender, biological or physiological attributes, financial status, health status, conduct, risk appetite, criminal record, and the like, analyzing the captured information, profiling the users based on the analysis, categorizing the users based on the profiles, recommending one or more insurance products or plans based on the captured context of use (or exposure) of the at least one of smart fixed, portable and wearable computing and communications devices and one or more user attributes, such as device usage chronological behaviour, pattern, age, sex or gender, biological or physiological attributes, financial status, health status, conduct, risk appetite, criminal record, and the like, and tracking efficacy of the recommendations made.

As used herein, the term “context of use” refers to the actual conditions under which a given artifact/software product, for instance the at least one of smart fixed, portable and wearable computing and communications devices running a SOA-based Insurance-As-A-Service (SOAIAAS) application, is used, or may be used in a normal day to day working situation. Context of use is important to carry out usability tests, prototyping sessions, meetings, user studies and other “user-dependant sessions” in the context of use to get as high ecological validity of findings as possible.

In some embodiments, deployment of at least one of smart portable and wearable multi-network access gateways (or network agnostic gateways) designed and implemented in accordance with the principles of the present invention, thereby facilitating emergency communication between one or more Data Terminal Equipments (DTEs), Data Circuit-Terminating Equipments (DCEs) and Data Transmission Circuits in any given network is disclosed, according to one or more embodiments.

In the one or more embodiments, for example, and in no way limiting the scope of the invention, the at least one of smart portable and wearable multi-network access gateway (or network agnostic gateway) is at least one of a Satellite Network Access Gateway (SNAG), Wireless Network Access Gateway (WNAG) and combination thereof. Specifically, the SNAG facilitates exchange of information between one or more satellites and the at least one of smart portable and wearable computing and communications devices. More specifically, the SNAG facilitates at least one of transmission and reception of information, for instance audio, video, data, multimedia and combinations thereof, to and from the at least one of smart portable and wearable computing and communications devices and the one or more satellites.

In some advantageous embodiments, a method of managing event-based people detection and tracking using the wearable computing and communications devices designed and implemented in accordance with the principles of the present invention is disclosed, thereby facilitating implementation of at least one of in advance preventive measures and at least one of in time and Just-In-Time (JIT) curative measures in at least one of known, unknown, timely, untimely, expected, unexpected, wanted, unwanted events occurring anyhow and anywhere autonomously automatically by virtue of at least one the actions of at least one of nobody and nothing, and at least one of partially manually and fully automatically by virtue of at least one the actions of at least one of anybody and anything. The method comprises capturing one or more attributes of at least one of an event, people, timings, location, things, ambience and incidents thereof, profiling people based on at least one of the stored overall profile (behavior profile, biological profile, personal profile, public profile) thereof, the location of the event, timings associated with the event, ambience and things in at least one of proximity and vicinity of the event, incidents occurring in the event and at least a combination thereof, categorizing people based at least in part on the profiling, generating user-defined rules for at least one of detection and tracking of people and a combination thereof based on the categories of the people, providing recommendations in connection with at least one of detection and tracking of people and a combination thereof based on the categories of the people, and tracking the efficacy of the recommendations.

In some embodiments, multilevel, comprehensive, adaptive and dynamic Authentication, Authorization and Accounting (AAA) of overall context to which any and all entities, places, things and people, for instance parties (or stakeholders) involved in any transaction, are at least one of subjected to, prone to, susceptible to, exposed to, party to, witness to and involved in actions performed by them and interactions therebetween, thereby facilitating effective evidence management and law enforcement comprising trial (or prosecution) and conviction is disclosed, in accordance with the principles of the present invention. In some scenarios involving commuters availing car rental services, a user (or commuter) owning and operating the wearable computing and communications device of the present invention initiates a request using a proprietary app installed and running thereon to hire or book a cab. Depending on the current location of the user, one or more cabs available in the area in at least one of vicinity and proximity of the current location of the user are displayed as ready to hire cabs. Further, the request to hire is sent to a server. Still further, the request is received by a driver. In response, the driver responds to the request and the confirmation is received on the side of the user. Further, the driver arrives at the requested source location to pick up the user. Upon boarding, the user initiates the client-side 152 of the proprietary client-server SOAPSAAS application (app) 146, thereby facilitating AAA of one or more potential routes from the current source location to the requested destination location of the user, potential time periods of travel, and the start and end times therefor, potential dates of travel, potential cab service providers, the drivers and cabs thereof, from the standpoint of safety and security of the user. In some scenarios involving identification and consideration of one or more potential routes, time periods of travel, start and end times therefor, dates of travel, cab service providers, drivers and cabs thereof, the server-side 150 of the proprietary client-server SOAPSAAS application (app) 146 facilitates recommendation of at least one most optimal route, time period of travel, start and end time therefor, date of travel, cab service provider, driver and cab thereof.

In some scenarios, upon arrival of the cab, the driver of the cab is required to undergo at least one of one or more biometric authentication, for instance fingerprint biometric authentication, retinal biometric authentication and iris biometric authentication, on-the-spot using the wearable computing and communications device owned and operated by the at least one of driver and user, thereby facilitating Authentication, Authorization and Accounting (AAA) of the driver. Upon successful biometric authentication of the driver, the vehicle or cab is subjected to overall health status check using the wearable computing and communications device owned and operated by the user. In some scenarios, in the event that the cab successfully surpasses the overall health status check comprising at least one of 1) the status of the panic button or kill switch installed in the cab, 2) the status of the GPS receiver installed in the cab, 3) the status of at least one of one or more add-on components, for instance a microphone, camera, and the like, the user approves the ride and the billing starts. The billing is controlled by the user, and thus the driver has no control or say over billing.

### Example Computer System

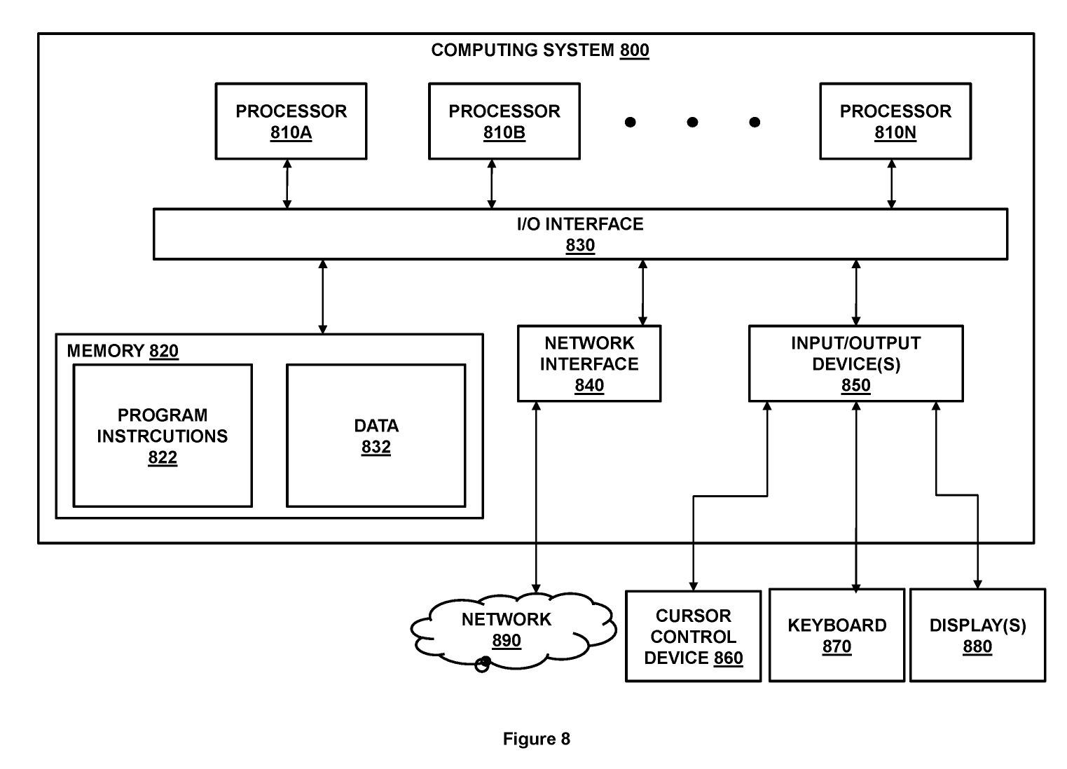

FIG. 8 depicts a computer system that may be a computing device and may be utilized in various embodiments of the present invention.

Various embodiments of the method and system for managing public safety in at least one of unknown, unexpected, unwanted and untimely situations via offering indemnity in conjunction with wearable computing and communications devices, as described herein, may be executed on one or more computer systems, which may interact with various other devices. One such computer system is computer system 800 illustrated by FIG. 8, which may in various embodiments implement any of the elements or functionality illustrated in FIGS. 1-7. In various embodiments, computer system 800 may be configured to implement one or more methods described above. The computer system 800 may be used to implement any other system, device, element, functionality or method of the above-described embodiments. In the illustrated embodiments, computer system 800 may be configured to implement one or more methods as processor-executable executable program instructions 822 (e.g., program instructions executable by processor(s) 810A-N) in various embodiments.

In the illustrated embodiment, computer system 800 includes one or more processors 810A-N coupled to a system memory 820 via an input/output (I/O) interface 830. The computer system 800 further includes a network interface 840 coupled to I/O interface 830, and one or more input/output devices 850, such as cursor control device 860, keyboard 870, and display(s) 880. In various embodiments, any of components may be utilized by the system to receive user input described above. In various embodiments, a user interface (e.g., user interface) may be generated and displayed on display 880. In some cases, it is contemplated that embodiments may be implemented using a single instance of computer system 800, while in other embodiments multiple such systems, or multiple nodes making up computer system 800, may be configured to host different portions or instances of various embodiments. For example, in one embodiment some elements may be implemented via one or more nodes of computer system 800 that are distinct from those nodes implementing other elements. In another example, multiple nodes may implement computer system 800 in a distributed manner.

In different embodiments, computer system 800 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 800 may be a uniprocessor system including one processor 810, or a multiprocessor system including several processors 810 (e.g., two, four, eight, or another suitable number). Processors 810A-N may be any suitable processor capable of executing instructions. For example, in various embodiments processors 810 may be general-purpose or embedded processors implementing any of a variety of instruction set architectures (ISAs), such as the x96, POWERPC®, SPARC®, or MIPS® ISAs, or any other suitable ISA. In multiprocessor systems, each of processors 810A-N may commonly, but not necessarily, implement the same ISA.

System memory 820 may be configured to store program instructions 822 and/or data 832 accessible by processor 810. In various embodiments, system memory 820 may be implemented using any suitable memory technology, such as static random access memory (SRAM), synchronous dynamic RAM (SDRAM), non-volatile/Flash-type memory, or any other type of memory. In the illustrated embodiment, program instructions and data implementing any of the elements of the embodiments described above may be stored within system memory 820. In other embodiments, program instructions and/or data may be received, sent or stored upon different types of computer-accessible media or on similar media separate from system memory 820 or computer system 800.

In one embodiment, I/O interface 830 may be configured to coordinate I/O traffic between processor 810, system memory 820, and any peripheral devices in the device, including network interface 840 or other peripheral interfaces, such as input/output devices 850. In some embodiments, I/O interface 830 may perform any necessary protocol, timing or other data transformations to convert data signals from one components (e.g., system memory 820) into a format suitable for use by another component (e.g., processor 810). In some embodiments, I/O interface 830 may include support for devices attached through various types of peripheral buses, such as a variant of the Peripheral Component Interconnect (PCI) bus standard or the Universal Serial Bus (USB) standard, for example. In some embodiments, the function of I/O interface 830 may be split into two or more separate components, such as a north bridge and a south bridge, for example. Also, in some embodiments some or all of the functionality of I/O interface 830, such as an interface to system memory 820, may be incorporated directly into processor 810.

Network interface 840 may be configured to allow data to be exchanged between computer system 800 and other devices attached to a network (e.g., network 890), such as one or more external systems or between nodes of computer system 800. In various embodiments, network 890 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 840 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 850 may, in some embodiments, include one or more display terminals, keyboards, keypads, touchpads, scanning devices, voice or optical recognition devices, or any other devices suitable for entering or accessing data by one or more computer systems 800. Multiple input/output devices 850 may be present in computer system 800 or may be distributed on various nodes of computer system 800. In some embodiments, similar input/output devices may be separate from computer system 800 and may interact with one or more nodes of computer system 800 through a wired or wireless connection, such as over network interface 840.

Those skilled in the art will appreciate that computer system 800 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 800 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 800 may be transmitted to computer system 800 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for design and implementation of an integrated comprehensive public safety and emergency communication system involving use of at least one of portable and wearable computing and communications devices and Unmanned Aerial Vehicles (UAVs), comprising:
customizing the design of the at least one of portable and wearable computing and communications devices and proprietary application software thereof, thereby rendering the devices at least one of tamper-proof, tamper-resistant, tamper-evident and operable in at least one of one or more low power, encrypted access, encrypted operating and encrypted communication modes;
customizing the implementation of the at least one of custom-designed portable and wearable computing and communications devices and the proprietary application software thereof, thereby rendering the same failover capable, fault-tolerant, fail-safe and operable in at least one of real-time and near real-time;
configuring the at least one of custom-designed and implemented portable and wearable computing and communications devices and the proprietary mobile application software thereof for use in at least one of unknown, unexpected, unwanted and untimely situations;
at least one of automatically and partially manually capturing at least one of textual data, still images, video, audio and a combination thereof in at least one of unknown, unexpected, unwanted and untimely situations as evidence using the at least one of custom-designed and implemented portable and wearable computing and communications devices, thereby facilitating timely management of the aforementioned situations;
at least one of automatically and partially manually, simultaneously storing the captured data for processing and later use plus transmitting the captured data in at least one of real-time and near real-time, using at least one of one or more available wireless networks based on one or more wireless video and data distribution techniques, to at least one of primary recipients, emergency contacts and a combination thereof;
upon failure to receive at least one of proof of delivery, read, approval receipt and a combination thereof from the primary recipients, at least one of automatically and partially manually forwarding the captured data to one or more peers of the primary recipients;
upon failure to receive at least one of proof of delivery, read, approval receipt and a combination thereof from the peers of the primary recipients, at least one of automatically and partially manually forwarding the captured data to one or more supervisors of the primary recipients and peers thereof; and
upon receipt of at least one of proof of delivery, read, approval receipt and a combination thereof from at least one high-level strategic decision making public authority managing the at least one of law enforcing, policing, fire and other emergency disaster management authorities, at least one of automatically and autonomously flying the UAVs to the detected locations in connection with at least one of unknown, unexpected, unwanted and untimely situations.

2. The method of claim 1, wherein the step of configuring the at least one of custom-designed and implemented portable and wearable computing and communications devices and the proprietary mobile application software thereof for use in at least one of unknown, unexpected, unwanted and untimely situations further comprises:
at least one of automatically and manually identifying and selecting one or more safe locations so as to populate a list of safe locations,
at least one of automatically and manually identifying and selecting one or more trusted group members so as to populate a list of trusted members, and
at least one of automatically and manually identifying and selecting one or more safe time slots in given time periods to traverse the identified and selected list of safe locations.

3. The method of claim 2, wherein the automatic identification and selection of the list of safe locations is based on recommendations provided by the at least one of custom-designed and implemented portable and wearable computing and communications devices and the proprietary mobile application software thereof in connection with one or more locations previously traversed by users.

4. The method of claim 2, wherein the automatic identification and selection of the list of trusted members is based on recommendations provided by the at least one of custom-designed and implemented portable and wearable computing and communications devices and the proprietary mobile application software thereof in connection with one or more trusted members from whom the users received timely help in the past.

5. The method of claim 1, wherein the at least one of one or more low power modes may be at least one of in at least one of sleep, hibernation, hybrid sleep, Advanced Configuration and Power Interface (ACPI) power modes and deep sleep mode.

6. The method of claim 1, wherein the at least one of custom-designed and implemented portable and wearable computing and communications devices and the proprietary mobile application software thereof may be designed to at least one of be implemented in, automatically select from and implement, selectively implement from, one or more user-defined explicit operation modes based on at least one of selective activation, deactivation and a combination thereof of one or more add-on components thereof.

7. The method of claim 6, wherein the one or more add-on components may be at least one of an imaging device, a GPS sensor (receiver), GSM unit, one or more sensors, one or more auxiliary wireless communication units and one or more auxiliary positioning units.

8. The method of claim 7, wherein the one or more user-defined explicit operation modes based on at least one of selective activation, deactivation and a combination thereof of one or more add-on components thereof may be at least one of mapped onto and correspond to one or more potential real-time use case scenarios in connection with the at least one of unknown, unexpected, unwanted and untimely situations.

9. The method of claim 1, wherein the at least one of custom-designed and implemented portable and wearable computing and communications devices and the proprietary mobile application software thereof may be designed to at least one of be implemented in, automatically select from and implement, selectively implement from, one or more user-defined explicit operation modes based on selective failover to one or more standby wireless networks upon at least one of network failure, unavailability and timeout.

10. The method of claim 1, wherein the at least one of custom-designed and implemented portable and wearable computing and communications devices and the proprietary mobile application software thereof may facilitate at least one of people detection by tracking and people tracking by detection.

11. The method of claim 1, wherein the at least one of custom-designed and implemented portable and wearable computing and communications devices and the proprietary mobile application software thereof may facilitate complex event processing.

12. The method of claim 1, wherein the at least one of custom-designed and implemented portable and wearable computing and communications devices and the proprietary mobile application software thereof are capable of operating in a training and learning mode.

13. The method of claim 1, wherein the at least one of portable and wearable computing and communications devices are Plug and Play (PnP) devices.

14. The method of claim 1, wherein the at least one of at least one of custom-designed and implemented portable and wearable computing and communications devices are at least one of wiredly and wirelessly chargeable.

15. The method of claim 1, wherein the proprietary application software is a proprietary client-server Service-Oriented Architecture (SOA)-based Public Safety-As-A-Service (SOAPSAAS) application (app), and wherein the principles of service-orientation are independent of any vendor, product or technology, thereby rendering the SOA at least one of vendor, product, technology agnostic and a combination thereof.

16. The method of claim 1, wherein the integrated comprehensive public safety and emergency communication system facilitates managing public safety in at least one of unknown, unexpected, unwanted and untimely situations via offering indemnity in conjunction with wearable computing and communications devices.

17. The method of claim 15, wherein the proprietary client-server SOAPSAAS app installed and running on each of the at least one of portable and wearable computing and communications devices facilitates capturing at least one of a past and current overall context of travel of the users, and family, friends, colleagues, contacts thereof, analyzing the captured at least one of the past and current overall context of travel of the users, and family, friends, colleagues, contacts thereof, profiling the users, and family, friends, colleagues, contacts thereof based on the analyses, categorizing the users, and family, friends, colleagues, contacts thereof based on the profiling, recommending safety and security measures as well as one or more insurance products, solutions and services.

18. The method of claim 17, wherein the one or more insurance products, solutions and services comprise at least one of Usage-Based Insurance (UBI), Pay As You Drive (PAYD), Pay How You Drive (PHYD), mile-based auto insurance and Behavior-based insurance.
